(19) United States
(12) Patent Application Publication
(10) Pub. No.: US 2015/0305041 A1
(43) Pub. Date: Oct. 22, 2015

(54) METHOD AND APPARATUS FOR PROVIDING SERVICE USING RADIO RESOURCE AGGREGATION

(71) Applicant: Electronics and Telecommunications Research Institute, Daejeon (KR)

(72) Inventor: Jae Heung KIM, Daejeon (KR)

(21) Appl. No.: 14/688,288

(22) Filed: Apr. 16, 2015

(30) Foreign Application Priority Data
Apr. 16, 2014 (KR) 10-2014-0045627
Apr. 28, 2014 (KR) 10-2014-0051056
Jun. 2, 2014 (KR) 10-2014-0067143
Jun. 26, 2014 (KR) 10-2014-0079189
Apr. 2, 2015 (KR) 10-2015-0047097

(51) Int. Cl. H04W 72/04; H04L 1/00; H04W 24/10; H04W 72/08

(52) U.S. Cl. CPC H04W 72/0453; H04W 72/085; H04W 72/0406; H04L 1/0003; H04W 24/10; H04W 84/12

(57) ABSTRACT

Provided are a connection configuring method between a base station and a node, and a terminal, a scheduling method for a radio resource in a unlicensed band, and a protocol stack regarding data transfer through the radio resource in the unlicensed band, for a terminal to receive a service by using a radio resource in a licensed band and the radio resource in the unlicensed band.

### CROSS-REFERENCE TO RELATED APPLICATION

This application claims priority to and the benefit of Korean Patent Application Nos. 10-2014-0045627, 10-2014-0051056, 10-2014-0067143, 10-2014-0079189, and 10-2015-0047097 filed in the Korean Intellectual Property Office on Apr. 16, 2014, Apr. 28, 2014, Jun. 2, 2014, Jun. 26, 2014, and Apr. 2, 2015, the entire contents of which are incorporated herein by reference.

### BACKGROUND OF THE INVENTION

1. (a) Field of the Invention

The present invention relates to a method and an apparatus for providing a service using radio resource aggregation of a radio resource in a licensed band and a radio resource in an unlicensed band.

2. (b) Description of the Related Art

A cellular mobile communication system has a bandwidth scalability feature supporting various system bandwidths, and may improve a data rate by using carrier aggregation (CA) technology. Further, even in a wireless local area network (WLAN) using a frequency (for example, an industrial, scientific, and medical (ISM) frequency, and the like) in an unlicensed band, which does not require frequency use permission, the data rate is improved through CA using one system bandwidth or multiple input multiple output (MIMO) technology using multiple antennas. In the WLAN system, since a method for alleviating inter-access point (AP) or user area is not efficient, service quality needs to be enhanced in a boundary region of an AP or a user concentration region.

In general, in order to reduce the inter-user interface in the unlicensed frequency band, a regulation against a maximum output or a spreading factor of the frequency is provided. Further, a user receives a communication service by using a communication apparatus (for example, wireless fidelity (WiFi) or the WLAN system) of which a format is approved. The unlicensed frequency band is set worldwide to 900 MHz, 2.4 GHz, and 5.7 GHz bands, and the like, and a WLAN wireless communication standard scheme such as Bluetooth or IEEE 802.11 operates in the unlicensed frequency band. At present, a data transmission amount of the wireless communication system including a mobile communication system is rapidly increasing, and various researches are in progress in order to accommodate a required data transmission amount which has explosively increased.

### SUMMARY OF THE INVENTION

The present invention has been made in an effort to provide a method and an apparatus which can provide a service to a terminal by using a radio resource in an unlicensed band together with a radio resource in a licensed band so as to accept a required data transmission amount.

An exemplary embodiment of the present invention provides a method for providing a service using radio resource aggregation by a base station. The method includes: receiving, from a terminal, a measurement result for one or more nodes positioned on the periphery of the terminal; and aggregating radio resources of a first node among one or more nodes and the base station based on the measurement result to provide the service to the terminal through the first node.

The method may further include: transmitting and receiving control information to and from the first node; and transmitting information on the first node to the terminal.

The providing may include transferring all packet data of the service to the terminal through the first node when off-loading is supported.

The providing may include transferring the packet data of the service to the terminal by aggregating one or more first carriers allocated to the base station and one or more second carriers allocated to the first node when carrier aggregation (CA) is supported.

The providing may include transferring the packet data to the terminal by aggregating one or more first radio resources allocated to the base station and one or more second radio resources allocated to the first node when radio resource aggregation (RRA) is supported.

The first node may be a node of a mobile communication network using an unlicensed frequency band.

Another exemplary embodiment of the present invention provides a method for receiving a service of an apparatus of a mobile communication network using an unlicensed frequency band. The method includes: discovering whether another wireless apparatus using a contention-based area exists in the contention based area included in a radio frame of the mobile communication network; and receiving, when occupying a first radio resource included in the contention based area is possible based on the discovery result, the service from a base station of the mobile communication network or a node of the mobile communication network using the unlicensed frequency band by using the first radio resource.

The method may include: being allocated a second radio resource in a non-contention based area included in the radio frame through scheduling of the base station; and receiving the service by using the first radio resource or the second radio resource.

The contention based area and the non-contention based area may occupy different parts in a time domain of the radio frame.

The contention based area and the non-contention based area may occupy different parts in a frequency domain of the radio frame.

Each of the contention based area and the non-contention based area may include one or more subframes, and the number of one or more subframes included in the contention based area and the number of one or more subframes included in the non-contention based area are different for each radio frame.

Each of the contention based area and the non-contention based area may include one or more subcarriers, and the number of one or more subcarriers included in the contention based area and the number of one or more subcarriers included in the non-contention based area are different for each radio frame.

Each of the contention based area and the non-contention based area may include one or more physical layer control channels to which the unit of the radio resource, a configuration scheme of the radio resource, and a determination scheme of a modulation and coding scheme (MCS) are similarly applied, and the number of one or more physical layer control channels included in the contention based area and the number of one or more physical layer control channels included in the non-contention based area are different for each radio frame.

The discovering may include sensing whether other wireless apparatus exists on the periphery before requesting the radio resource to the base station or the node of the mobile communication network.

The discovering may include discovering whether other wireless apparatus using the contention based area exists by measuring energy of a signal of the radio resource transmitting system information.

Yet another exemplary embodiment of the present invention provides a transmission apparatus for transmitting packet data by using a radio resource of a mobile communication network and a radio resource of a wireless local area network. The transmitting apparatus includes: a scheduler determining a transmission path of the packet data as one of a first transmission path of the mobile communication network, a second transmission path of the wireless local area network, and a third transmission path of the mobile communication network using a frequency in a unlicensed band; and a control unit transferring the packet data to one of the first transmission path, the second transmission path, and the third transmission path based on the determination of the scheduler.

The transmission apparatus may further include a convergence function block for an interface between a packet data convergence protocol (PDCP) layer based on the mobile communication network and a media access control (MAC) layer of the wireless local area network.

The convergence function block may convert a packet data unit (PDU) of the PDCP layer in accordance with a service data unit (SDU) of the MAC layer.

The control unit may serve as the packet data convergence protocol (PDCP) layer of the mobile communication network.

The control unit may serve as a radio link control (RLC) layer of the mobile communication network.

According to exemplary embodiments of the present invention, a terminal is connected with a base station using a radio resource in a licensed band and a node using a radio resource in an unlicensed band to receive a service based on scheduling through radio resource aggregation and a protocol structure.

### BRIEF DESCRIPTION OF THE DRAWINGS

FIG. 1 is a diagram illustrating a hierarchical wireless network according to an exemplary embodiment of the present invention.

FIG. 2 is a diagram illustrating a wireless network connected with wired/wireless backhauls according to an exemplary embodiment of the present invention.

FIG. 3 is a flowchart illustrating a method for aggregating a radio resource according to an exemplary embodiment of the present invention.

FIG. 4 is a flowchart illustrating a method for aggregating a radio resource according to another exemplary embodiment of the present invention.

FIGS. 5A to 5E are diagrams illustrating a radio frame of a U-LTE system according to an exemplary embodiment of the present invention.

FIG. 6 is a diagram illustrating a radio frame of a U-LTE system according to another exemplary embodiment of the present invention.

FIG. 7 is a diagram illustrating a wireless network according to another exemplary embodiment of the present invention.

FIG. 8 is a diagram illustrating a protocol stack of a U-LTE system according to an exemplary embodiment of the present invention.

FIG. 9 is a diagram illustrating a protocol stack of a U-LTE system according to another exemplary embodiment of the present invention.

FIG. 10 is a block diagram illustrating a wireless communication system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may be designated as a terminal, a mobile terminal (MT), an advanced mobile station (AMS), a high reliability mobile station (HR-MS), a subscriber station (SS), a portable subscriber station (PSS), an access terminal (AT), user equipment (UE), and the like, and includes all or some functions of the MT, the MS, the AMS, the HR-MS, the SS, the PSS, the AT, the UE, and the like.

Further, a base station (BS) may be designated as an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (ARS) serving as the base station, a high reliability relay station (HR-RS) serving as the base station, small-sized base stations [femoto BS, a home node B (HNB), a home eNodeB (HeNB), a pico BS, A metro BS, a micro BS, and the like], and the like, and includes all or some functions of the ABS, the NodeB, the eNodeB, the AP, the RAS, the BTS, the MMR-BS, the RS, the RN, the ARS, the HR-RS, the small-sized base stations, and the like.

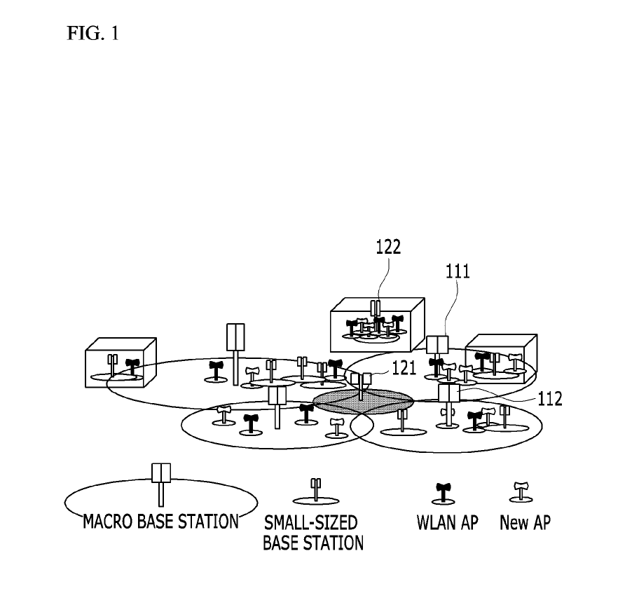

FIG. 1 is a diagram illustrating a hierarchical wireless network according to an exemplary embodiment of the present invention.

Referring to FIG. 1, each node included in the hierarchical wireless network is a node that provides a mobile communication service or a service using a frequency in an unlicensed band. That is, referring to FIG. 1, in the hierarchical wireless network, a plurality of base stations (alternatively, cells) and APs (alternatively, transmission points (TPs)) are components of a hierarchical environment. The base station may cover a macro layer having a large service area and a small-sized base station or AP may cover a micro layer having a relatively small service area.

Mobile communication and wireless communication services may be provided in heterogeneous frequency bands through the hierarchical wireless network illustrated in FIG. 1.

In the wireless network providing the service by using the frequency in the unlicensed band, an edge node of the network (hereinafter referred to as a ‘network node’) may be configured in the form of the base station in the mobile communication system or the AP of a WLAN system. In particular, a radio standard of a 3^{rd} Generation Partnership Project (3GPP) system or a long term evolution-advanced (LTE-A) system may be applied to a new access interface for a radio interface between the node (for example, the base station, a cell, a radio remote head (RRH), the TP, or AP) of the system using the frequency in the unlicensed band and the terminal. In the exemplary embodiment of the present invention, a node using the frequency in the unlicensed band by applying a new radio access interface based on a radio interface of an LTE or LTE-A system is referred to as a new AP. The new AP may be configured in the form of the WLAN system in the related art or constituted by the base station, the cell, the RRH, the TP, and the like of the mobile communication system. Accordingly, the new AP may support the new radio access interface through the frequency in the unlicensed band. The new AP transmits a beacon or advertisement information transmitted in the WLAN AP in the related art or transmits system information in a similar method as the base station of the mobile communication system to transfer common information to the terminal in a service area of the new AP.

In FIG. 1, a frequency f1 of a macro base station and a frequency f2 of a small-sized base station may be equal to or different from each other. The small-sized base station of the micro layer may be deployed in an environment in which the macro base station exists or may independently provide the service outside an area of the macro base station. Further, the small-sized base stations 121 and 122 is deployed in an area other than the service area of the macro base station to extend the service area of the macro base station or provide service continuity for a coverage hole.

The macro base station and the small-sized base station, and the network, may be connected to an ideal backhaul or a non-ideal backhaul. The ideal backhaul connects the base station and the network point to point through an optical cable or a dedicated line such as a line of sight (LOS) superhigh frequency to have a high data rate and a low latency characteristic. The non-ideal backhaul as a typical backhaul constituted by a wired network in which transmission performance is limited and latency exists has a limited data rate and a some latency characteristic.

According to the exemplary embodiment of the present invention, the AP that provides the service by using the frequency in the unlicensed band may be deployed in the service area of the macro base station or the small-sized base station. According to the exemplary embodiment of the present invention, both the AP based on the WLAN in the related art and the new AP based on the new radio protocol (not the radio standard based on the WLAN) may provide the service in the hierarchical wireless network. The AP based on the WLAN in the related art and the new AP based on the new radio protocol may be operated while being deployed at the same position as the macro base stations 111 and 112. The AP and the new AP may be operated together with the mobile communication base station, the latency may be minimized in signaling between the base station and the AP, and a signaling interface may be further simplified.

According to the exemplary embodiment of the present invention, the new AP in the unlicensed frequency band, which supports the new radio access interface, may transmit the beacon or advertisement information transmitted by the AP in the WLAN system in the related art. Further, the new AP may transfer the common information to the terminal positioned in the service in the new AP by transmitting the system information to transfer a common control message (alternatively, a parameter) in a similar method as the base station in the mobile communication system. In this case, the common information may include information including an identifier (ID) of the new AP, system bandwidth and minimum bandwidth information, physical channel configuration information, uplink access channel information, information regarding whether to support an radio resource aggregation (RRA) function between inter-radio access technology (inter-RAT) such as the mobile communication base station, or information regarding whether to support an off-loading function.

The RRA function is a function in which two or more network nodes (the base station, the cell, the AP, and the like) use the radio resource together in order to provide the service to one terminal. The inter-heterogeneous system radio resource aggregation technology is also referred to as inter-RAT carrier aggregation (CA). By the RRA function, at least two nodes that follow different radio access interface may provide the service to the same terminal by using a frequency (alternatively, a subcarrier) of each radio access interface. When the RRA function is supported, both a licensed frequency and an unlicensed frequency may be used. In the exemplary embodiment of the present invention, the radio resource aggregation (RRA) function means a function to provide the service by using the radio resource of the wireless communication system (the mobile communication system such as the WCDMA, LTE, and LTE-A systems) using the frequency in the licensed band and the radio resource of the wireless communication system (WLAN or U-LTE system) using the frequency in the unlicensed band together.

The new AP provides the service to the terminal by using the frequency in the unlicensed band, but may follow an operation and a procedure of the mobile communication base station using the frequency in the licensed band when performing a configuration procedure for connection control, a procedure for radio resource allocation and resource management, a mobility control procedure, a measurement and reporting procedure, or a cooperation communication procedure with a continuous base station (alternatively, the AP) for providing the service to the terminal. For example, when the radio protocol between the new AP and the terminal is based on the radio protocol of the 3GPP LTE system while the new AP uses the unlicensed frequency band, the new AP may provide the service to the terminal at the same level as the base station of the LTE system. In particular, when the LTE base station provides a primary cell (PCell) and the new AP provides a secondary cell (SCell) through the CA function of the LTE-A system, the new AP may operate without a functional difference from the SCell in a CA environment of the LTE system.

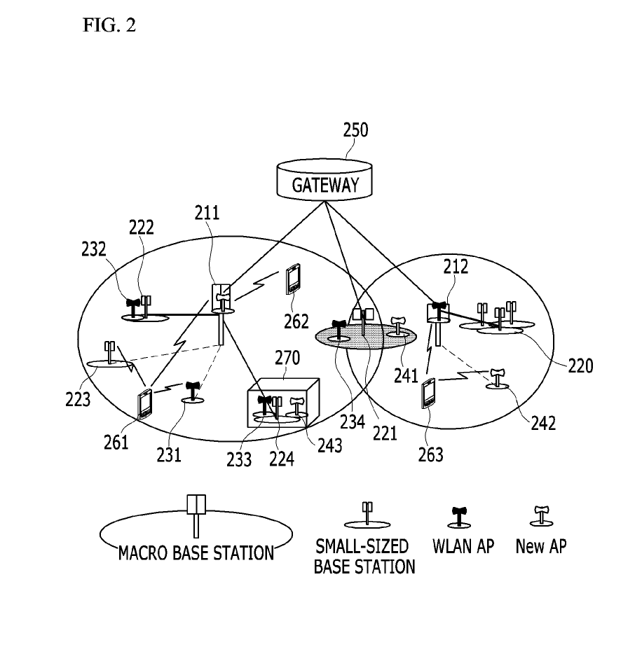

FIG. 2 is a diagram illustrating a wireless network connected with wired/wireless backhauls according to an exemplary embodiment of the present invention.

The backhaul means an interface section that connects the base station (alternatively, the AP) and a gateway (alternatively, a router). Accordingly, a radio interface that connects the base station and the gateway may be referred to as a wireless backhaul. Meanwhile, the base station includes a digital processing unit (DU) performing baseband processing and a radio and analog processing unit (RU) performing analog signal processing such as a radio frequency (RF) function. When the DU and the RU are physically separated from each other, an interface section that connects the DU and the RU may be referred to as a front-haul. Alternatively, an interface section that connects an RRH which is primarily configured by the RF function including an antenna to extend the service area or cover a shadow area and installed at a geographically different position from the base station, and the base station may be defined as the front-haul. When connection of the front-haul section is configured wirelessly, it may be referred to as a radio front-haul. In the exemplary embodiment of the present invention, when the interfaces among the base station, the gateway, and the base station function block positioned at the geographically separated position are configured wirelessly, both the radio front-haul and the wireless backhaul are commonly called the wireless backhaul.

The new AP according to the exemplary embodiment of the present invention may configure the wireless communication network in the new radio access standard by using the frequency in the unlicensed band. Macro base stations 211 and 212 of the mobile communication system maintain an interface with a gateway 250 to provide the mobile communication service to terminals 261, 262, and 263. A small-sized base station 221 which forms the interface directly with the gateway 250 and small-sized base stations 222 and 223 that form the interface indirectly with the gateway 250 through the macro base station may also provide the mobile communication service to the terminal.

Further, one or more small-sized base stations 221, 222, and 223 may exist and WLAN-based WLAN APs 231, 232, 233, and 234 may exist in a service area of the macro base station 211. A small-sized base station cluster 220 in which a plurality of small-sized base stations provide the service together may exist in another macro base station 212. The WLAN AP 234 and a new AP 241 may exist in a service area of the small-sized base station 221 positioned in a service boundary area of the macro base station 211 and another macro base station 212. Meanwhile, according to the exemplary embodiment of the present invention, the wireless network may be configured in a building 270 and the like, in which a new AP 243, the small-sized base station 224, and the WALN AP 233 that provide the new radio access standard exist together.

The macro base stations 211 and 212 and the small-sized base stations 221, 222, 223, and 224, or the macro base stations 211 and 212 and the small-sized base station cluster 220, may be connected directly through wired cables (an optical cable, a coaxial cable, and the like) or indirectly through the gateway 250. Further, the small-sized base station 223, the WLAN AP 231, and a new AP 242 may be wirelessly connected with the macro base stations 211 and 212. In this case, the small-sized base station 223, the WLAN AP 231, and the new AP 242 may be connected to the gateway 250 through wired connection between the macro base stations 211 and 212 and the gateway 250. In general, the backhaul means connection between the base station and the gateway, but according to the exemplary embodiment of the present invention, wireless connection between the small-sized base station, the WLAN AP, or the new AP, and the macro base station may be referred to as the wireless backhaul.

According to the exemplary embodiment of the present invention, the new radio access interface through the frequency in the unlicensed band may be applied to the wireless backhaul through the macro base station, and the small-sized base station, the WLAN AP, and the new AP. The small-sized base stations 220 to 224 included in the service areas of the macro base stations 211 and 212 may use the same frequency as or a difference frequency from the macro base stations 211 and 212. Further, in the exemplary embodiment of the present invention, a frequency (alternatively, a system bandwidth) when the new AP 242 provides the service to the terminals 261 to 262 may be the same as or different from the frequency that the new AP 242 uses to operate the wireless backhaul.

A characteristic that data of the mobile communication network is off-loaded to the WLAN system is important in the hierarchical wireless network. However, since the WLAN system and the mobile communication system are different from each other in terms of an access scheme, a scheduling scheme, and a radio resource structure, it is difficult to secure service continuity through tight coupling between both systems. In this case, when some functions are provided in terms of the radio access network (RAN), interlocking of the WLAN system and the mobile communication system may be efficiently provided. For example, a WLAN AP discovery procedure of the terminal is enhanced or there is a method that transfers information on a service attribute.

If a limit for a WLAN AP discovery is not configured in a terminal that supports both the WLAN system and the mobile communication system, battery consumption of the terminal may be high. Accordingly, only when a general user activates a WiFi function does the terminal discover the AP. Alternatively, even when the WiFi function is activated, the terminal may periodically discover the AP according to a separately set timer or discover the AP based on AP information provided from the mobile communication system or stored information.

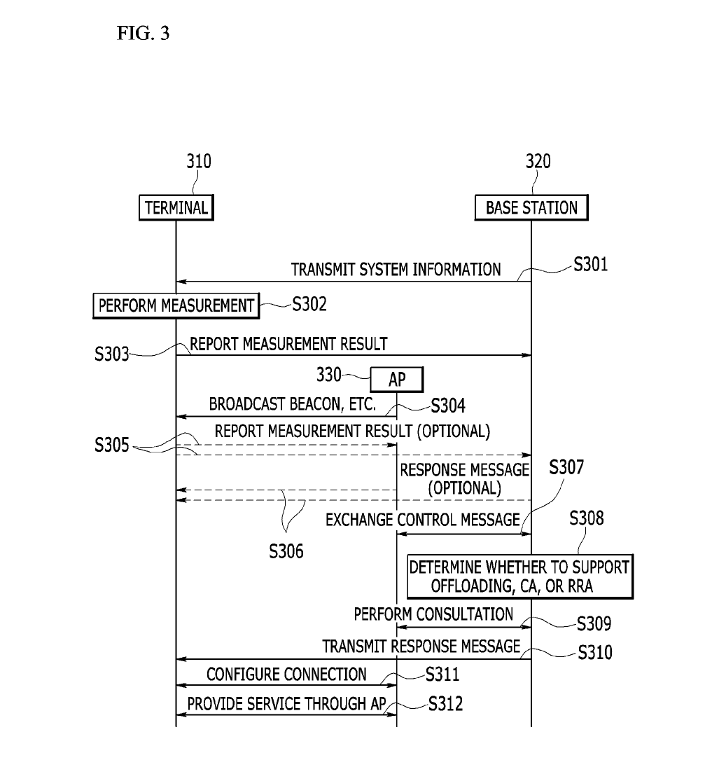

FIG. 3 is a flowchart illustrating a method for aggregating a radio resource according to an exemplary embodiment of the present invention.

Referring to FIG. 3, the AP as a node using the frequency in the unlicensed band may be one of the AP of the WLAN system, and the small-sized base station, the RRH, the TP, or the new AP of the mobile communication system. In this case, the new AP may support the new radio access interface through the frequency in the unlicensed band.

Referring to FIG. 3, the base station may exchange or collect information for offloading, AP discovery, measurement, and the like with the AP by transmitting a control signal.

First, the base station transmits the system information to a terminal 310 (S301). In this case, the base station may transmit AP information (for example, a service set identifier (SSID), WLAN frequency band information, positional information, synchronization information, or discovery information) of an AP which may be controlled or connected and AP measurement related information (for example, an AP measurement threshold value, measurement period information, and the like) to the terminal together with the system information. In this case, the base station may transmit the connectable AP information and the AP measurement related information to the terminal supporting the WLAN through a separate dedicated control message.

The AP information according to the exemplary embodiment of the present invention may be a list form, and may include identifier information of the connectable AP, the frequency band and the system bandwidth of the AP, and geographical position information of the AP. In the WLAN AP, the identifier information of the AP as an identifier for distinguishing the AP may be an SSID, a basic service set identifier (BSSID), or a homogeneous extended service set identifier (HESSID). In the case of the new AP, an identifier for the WLAN AP in the related art may be adopted, an identifier (for example, a physical cell identifier (PCI), a cell global identifier (CGI), or an enhanced UMTS ground radio access network (e-UTRAN) cell global identifier (ECGI)) for cell distinction of the LTE/LTE-A system may be adopted, or a new type of identifier for distinguishing the new AP may be used. The frequency band and system bandwidth information of the AP according to the exemplary embodiment of the present invention may include information indicating a transmission frequency of the AP in the list, the system bandwidth supported by the AP in the list, or radio standard version information supported by the AP in the list. In addition, the geographical position information of the AP according to the exemplary embodiment of the present invention may include positional information for a location based service (LBS) of the terminal or positional information for estimating the position of the terminal.

The AP measurement related information according to the exemplary embodiment of the present invention as a reference, event, or triggering condition which the terminal may use to determine whether to switch the AP for receiving or offloading the service by using the CA or RRA function from the AP may include a threshold value for AP reception power. For example, the base station according to the exemplary embodiment of the present invention may provide reference values (for example, threshold value) including a received signal strength indicator (RSSI), a signal to interference ratio (SIR), an energy per bit to noise spectral density ratio (Eb/No), a received channel power indicator (RCPI), a received signal to noise indicator (RSNI), a reference signal received quality (RSRQ), a reference signal received power (RSRP), a received signal code power (RSCP), and the like to the terminal through the system information as the AP measurement related information. When necessary, the terminal may measure received signal power with respect to the AP in the AP list of the system information or an AP included in measurement reporting parameters that the base station sets through the dedicated control message and report a measurement result of the received signal power to the base station.

Further, the base station according to the exemplary embodiment of the present invention may transmit to the terminal synchronization signal information regarding a synchronization signal for acquiring synchronization of the AP or setting synchronization with the AP by using the system information transmitted to the terminal. In addition, the base station 320 may transmit discovery signal information regarding a discovery signal for discovering a contiguous base station or AP that performs an on/off operation for energy saving to the terminal. In this case, the synchronization signal information or the discovery signal information may include a transmission period of the signal, a transmission position (information on a subframe or subcarrier in which the signal is transmitted), a repetition period of the signal, or scramble (alternatively, masking) sequence information. The base station according to the exemplary embodiment of the present invention may transmit the synchronization signal information or the discovery signal information to the terminal supporting the WLAN by using the dedicated control message.

Next, the terminal that receives the system information from the base station performs measurement with respect to an AP 330 positioned therearound by using AP information included in the system information (S302). In this case, a terminal in a connection state, which receives the service through the base station, may perform measurement for a peripheral AP or base station according to AP information acquired through a separate dedicated control signal from the base station or the measurement and reporting configuration of the base station.

The terminal according to the exemplary embodiment of the present invention may estimate or measure the synchronization signal or the discovery signal in order to support the on/off operation function of the base station or the AP. In this case, the terminal may measure the synchronization signal or the discovery signal in a background scheme or an autonomous scheme. Thereafter, the terminal may report a measurement result for the synchronization signal or the discovery signal to the base station or the AP by using the radio resource.

Next, the terminal that performs measurement for the AP positioned therearound reports a measurement result for a neighboring AP to the base station (S303). In this case, the terminal may transmit a control message to the base station for the offloading to the AP or requesting the CA or RRA through the radio resource together with reporting of the measurement result.

In the CA (alternatively, RRA) through the radio resources of the base station and the AP, the base station may operate as a primary base station function and the AP may operate as a secondary base station function. For example, the base station that charges the primary base station function may take charge of controlling exchange of a signaling message for supporting the CA and the AP that charges the secondary base station function may take charge of transmitting and receiving data without a control function. That is, for supporting the CA, the base station may provide both a control plane function for transmitting the signaling message and a user plane function for transmitting data, and the AP may provide only the user plane function for transmitting the data.

Unlike the CA in the related art, in particular, in the RRA, the base station and the AP may provide both the control plane function for transmitting the signaling message with the terminal and the user plane function for transmitting the data. However, for efficient transmission of the signaling message and configuration of a control parameter, one of the base station and the AP may perform the control plane function with priority by operating as a master node function and the other one may perform a function of a secondary node in terms of a control plane.

Meanwhile, the terminal may report function information to the base station AP indicating whether to support the AP in terms of a capability of the terminal or through a separate signaling message. For example, the terminal may report the AP function information (for example, an AP standard version, an available frequency band, and the like) supported by the terminal by using feature group indicator (FGI) information to the base station. The terminal may report the FGI information associated with the AP function supporting in registration in a mobile network or in step of a connection setup or establishment.

The AP according to the exemplary embodiment of the present invention broadcasts the beacon or advertisement information so that the terminals in the service area receive the beacon or advertisement information (S304). The AP of the WLAN system may broadcast the beacon or advertisement information. The new AP may broadcast basic common information of the new AP in the form of the beacon or advertisement information of the WLAN AP or broadcast the basic common information in the form of the system information like the base station of the mobile communication system.

In another exemplary embodiment of the present invention, the terminal may perform measurement for the peripheral AP based on the beacon or advertisement information broadcasted by the AP (S305). In this case, the terminal may report a measurement result for the neighboring AP to the base station and the AP and transmit the control message for requesting the offloading to the AP, the CA, or the RRA. That is, the terminal may report the measurement result for the neighboring AP to the base station and all APs therearound and transmit the control message for requesting the offloading to the AP, the CA, or the RRA. Alternatively, the terminal may configure connection with the AP (for example, allocate a resource to receive the service by attempting the access to the AP), report the measurement result for the neighboring AP together with the connection configuration information, and transmit the control message for requesting the offloading, the CA, or the RRA to the base station and the AP. Even in this case, the base station and the AP that receive the control message for requesting the offloading, the CA, or the RRA from the terminal may transmit a response message regarding whether to support the offloading, CA, or RRA function to the terminal (S306).

In addition, as described above, the base station and the AP may configure a separate interface to support the data offloading or RRA function with the terminal and exchange the control message through the configured interface (S307). A control signaling between the base station and the AP may be performed before starting supporting the offloading, CA, or RRA function or after starting an operation for supporting the offloading, CA, or RRA function.

The base station that receives the measurement result (in addition, an offloading, CA, or RRA request) of the peripheral AP determines whether to support the offloading, CA, or RRA function using the AP (308).

In the exemplary embodiment of the present invention, the base station may determine whether to support the data offloading, CA, or RRA function using the AP through cooperation with the terminal. For example, the base station may instruct transmitting the control message for verifying whether to support the data offloading, CA, or RRA function, transmitting information for requesting reporting whether to support the data offloading, CA, or RRA function to the terminal by using the system information, or transmitting information regarding whether to support the data offloading, CA, or RRA function while configuring connection with the base station. Alternatively, the terminal may display whether to support the data offloading, CA, or RRA function by using the capability information (for example, the FGI) of the terminal. In this case, the terminal that receives the control message for verifying whether to support the data offloading, CA, or RRA function from the base station may transmit the control message for verifying whether to support the data offloading, CA, or RRA function to the base station, and thereafter determine whether to use the data offloading, CA, or RRA function. That is, a procedure in which the terminal verifies whether to support the data offloading, CA, or RRA function may be first performed by requesting the function of CA, RRA, or data off-loading from terminal, transmitting and receiving related information in a connection configuring step of requesting the service through prior configuration information, or user's selection. When whether to support the data offloading, CA, or RRA function is determined according to the user's selection, the following information is displayed on a display of the terminal and a user may determine supporting the data offloading, CA, or RRA function through a verification procedure (an icon click or touch action).
Request (alternatively, verification) information of the base station to verify whether to use the data offloading, CA, or RRA function using the AP
Information representing the AP around the terminal

In addition, the base station performs cooperation for supporting the offloading, CA, and RRA functions with the AP and exchanges information required to support the offloading, CA, and RRA functions (S309).

Thereafter, the base station transmits the response message regarding whether to support the offloading, CA, and RRA functions to the terminal (S310). The base station may determine whether to support the offloading, CA, RRA functions according to reporting the measurement result for the peripheral AP of the terminal, inter-base station information exchange, information exchange with the AP, and determination of a network management/control function, and may determine supporting the offloading, CA, and RRA functions even when there is no request from the terminal.

When the base station determines supporting the offloading function, the base station may provide information on a target AP which the terminal will access for the data offloading to the terminal through the response message. Alternatively, when the base station determines supporting the CA or RRA function, the base station may provide, to the terminal through the response message, information on a target AP which the terminal will access for the CA or RRA, function sharing information between the base station and the AP for the CA or RRA, and configuration information for supporting the CA or RRA function. In this case, the information on the target AP which the base station transmits to the terminal may include identifier information of the target AP, information for an access procedure to access the target AP in a non-contention scheme, and radio resource allocation information for data transmission and reception. The terminal does not perform carrier sensing (CS) or the like by using the information on the target AP received from the base station or performs CS without a collision with exclusion of a contention with other WLAN apparatus included in an area of the target AP to receive the service through allocated frequency and time resources.

Thereafter, the terminal that receives the response message configures connection for receiving the service from the AP by accessing the target AP (S311). In the exemplary embodiment of the present invention, the terminal is allocated a resource which may receive the service from the AP by performing a random access (RA) procedure or an initial access procedure for an AP which is separately defined. Further, the terminal configures connection to transmit and receive control information or data to and from the AP. In this case, the terminal may configure physical layer synchronization between the AP and the terminal or control transmission power.

Thereafter, the terminal that completes the connection configuration with the AP receives the service from the AP through the offloading, CA, or RRA function. When the offloading function is supported, the terminal may receive the service by using only the AP while not releasing the connection with the base station according to control by the base station or determination by the terminal or the user. In addition, when the CA or RRA function using both the radio resources of the base station and the AP is supported, the terminal maintains access or connection to both the base station and the AP to receive the service.

Meanwhile, the terminal according to another exemplary embodiment of the present invention may perform the measurement for the AP by using the signal and the common information transmitted by the AP. In this case, the terminal does not use the AP information transmitted by the base station. That is, the terminal may configure the connection with the AP such as attempting the access to the AP and being allocated the resource capable of providing the service in order to receive the signal and the common information transmitted by the AP. Thereafter, the terminal may report the measurement result for the AP to the base station or the AP and transmit the control message for requesting supporting the offloading, CA, or RRA function. Alternatively, the terminal may not configure the connection with the AP, unilaterally report the measurement result to the base station or the AP, and transmit the control message for requesting supporting the offloading, CA, or RRA function. When the terminal requests supporting the offloading, CA, or RRA function without the AP information of the base station, the base station or the AP may transmit the response message for requesting supporting the offloading, CA, or RRA function to the terminal.

As described above, the terminal may offload the data of the mobile communication network by using the AP or receive the service to which the CA or RRA function using both the radio resources of the base station and the AP is applied. In this case, a control message including an AP discovery attempt is transmitted by a method in which the terminal reports the information of the AP to the base station, the user configures an activation function meaning the use of the AP, or the user clicks on an AP icon of a terminal monitor, and as a result, the data offloading, the CA, or the RRA may be provided to the user. The terminal may request the data offloading, the CA, or the RRA to the base station based on the AP information, and the data offloading is service switching to the AP and the CA, or the RRA is a concurrent service of the AP with the base station. In this case, the terminal may report an AP identifier, an AP received signal strength, load state information, preference AP information for cooperative communication with the AP, and the like to the base station.

The base station may transmit to the terminal in the service area of the base station a system information block (SIB) configuring the system information and an AP SIB transmitting AP related information and a related parameter. In this case, the base station as the AP SIB transmits the AP information (for example, AP identifier information, AP frequency band information, geographical position information of the AP, and the like) which may be controlled or connected by the base station, and AP measurement related information (for example, an AP measurement threshold value, measurement period timer information, and the like) to the terminal in the service area of the base station. The AP information may be configured in the form of a list in which at least one AP is included, and may include the identifier information on each AP, the frequency band and system bandwidth information of the AP, the geographical position in formation of the AP, and the like. For example, the AP identifier information as information representing an identifier for identifying the AP may include at least one of the SSID, the BSSID, and the HESSID in the case of the WLAN AP. In the case of the new AP, the AP identifier information may include base station identifier information of the LTE system or a partial identifier configured by a part of the base station identifier, a unique identifier to identify the new AP in the system, and a physical layer identifier for the new AP.

The AP frequency band and system bandwidth information included in the AP SIB may include at least one of information indicating a transmission frequency of the AP written in the AP list, the system bandwidth supported by the AP, and standard version information supported by the AP. The geographical position information of the AP may include position information provided for the LBS of the terminal or information provided to estimate the position of the terminal.

The AP measurement related information as a reference value for the AP measurement, which is used for the terminal to receive the service from the AP or to determine service switching for the data offloading, may be a reference value for the AP received power. For example, a reference value such as RSSI, SIR, EbNo, RCPI, RSNI, RSRP, RSRQ, or RSCP may be provided from the base station through the AP SIB. Further, when necessary, the terminal may measure a received power with respect to the AP in the AP list of the AP SIB or an AP included in the measurement reporting parameters which the base station sets through the dedicated control message and report a measurement result to the base station.

The AP SIB may include load status information of the AP included in the service area of the base station. The load status information of the AP may be transmitted by the AP through the beacon (alternatively, separate system information) or load status information of the AP collected by the base station through a separate procedure. In the exemplary embodiment of the present invention, the terminal may attempt accessing the AP and report information on access success rate or access failure rate for the AP which the terminal attempts to access during a predetermined time interval (alternatively, a timer) to the base station, in order for the base station to measure the load status of the AP included in the service area of the base station. Alternatively, the terminal may measure a data amount (alternatively, data rate) of data which the terminal receives from the access AP or transmits to the access AP during a predetermined time interval (alternatively, timer) after accessing the AP, data retransmission rate, a required time up to acquiring the resource after the CS (for acquiring the radio resource), or a required time from a time required to acquire the resource to the required time up to acquiring the resource, and report the measurement result to the base station.

When the AP SIB is changed, the base station may notify a change of the AP SIB to the terminal in the service area of the base station apart from notification of a change of the system information. According to the exemplary embodiment of the present invention, in order for the base station to notify the change of the AP SIB to the terminal apart from the notification of the change of the system information, some scheduling identifiers among scheduling identifiers (for example, a cell-radio network temporary identifier (C-RNTI), and the like) may be fixedly allocated to the terminal in terms of the base station or the system. The base station may notify the change of the AP SIB to the terminal by using the fixedly allocated scheduling identifier (for example, an AP-RNTI). When the terminal is in an ‘AP in use’ status to receive the service through the AP, the terminal is scheduled to use an AP function (that is, a function to provide the service through the WLAN AP or the new AP) or the terminal is in an activation status (for example, a WLAN AP or new AP function of the terminal is activated), the terminal may detect the AR-RNTI and receive the changed AP SIB in an area in which scheduling information is transferred, and thereafter update the AP SIB. When the terminal does not use the AP function of the terminal or the AP function of the terminal is in an inactive status (deactivation), the terminal may ignore detection of the AR-RNTI or skip updating the AP SIB.

Further, according to the exemplary embodiment of the present invention, the base station may use the AR-RNTI in order to transmit the control message for the AP and additionally allocate the RNTI for interlocking with the AP. In the exemplary embodiment of the present invention, the RNTI which additionally allocates for interlocking with the AP is referred to as AR-RNTI₂. The base station may transmit the scheduling information to a physical layer control channel (for example, a physical downlink control channel (PDCCH) or an improved PDCCH (ePDCCH)) of the LTE system by using the AP-RNTI or AP-RNTI₂. Thereafter, the terminal may apply a modulation and coding scheme (MCS) indicated by the scheduling information transmitted by using the AR-RNTI or AR-RNTI₂ and transmit a control message associated with an operation of the AP through the radio resource on a physical downlink shared channel (PDSCH).

The control message for the operation of the AP may be configured in the form of the AP list by using the AP SIB. Further, the control message of the operation of the AP may include at least one of the AP information (for example, the identifier information of the AP, the frequency band and system bandwidth information of the AP, and the geographical position information of the AP), the AP measurement related information (for example, the AP measurement threshold value, the measurement period timer information, and the like), or the load status information of the accessible AP.

When necessary, the base station may transfer the control message for the operation of the AP to the terminal as a dedicated control message by using a scheduling identifier (C-RNTI) which is uniquely allocated to the terminal. Further, when necessary, the base station may transmit the resource allocation information for the target AP of the offloading to the terminal through the dedicated control message for offloading the data to the AP.

In the exemplary embodiment of the present invention, the base station may select the target AP based on the measurement result of the terminal, prior negotiation for co-operation between the base station and the AP, or operations and maintenance (OAM) of the network in order to efficiently provide the offloading function. In information exchange (alternatively, negotiation for co-operation) between the base station and the target AP of the selected offloading, the AP may transfer the AP resource allocation information for the offloading terminal to the base station and the base station may transfer the resource allocation information of the target AP to the terminal. The terminal may be allocated the frequency and time resources without the procedure such as the CS and the like or through the CS with exclusion of a contention (without a collision) with another AP positioned in the service area of the target AP and receive the service through the allocated frequency and time resources, by using the resource allocation information of the target AP.

When the control message for the operation of the AP in the base station, which is transmitted by a method other than a transmission method of the AP SIB information or a transmission method of the system information is configured in the list form, the order of the list may represent an access easiness order to the AP. In this case, in the case of the access to the AP, an access priority to the AP or the load status may be considered.

In the exemplary embodiment of the present invention, when the terminal configures the information on the AP in the form of the list and reports the information on the AP, as the order of the APs included in the list in a report control message, a preference AP priority, a designated AP order of the base station, or an order depending on the received signal strength may be represented.

Preference information of the terminal transmitted to the base station from the terminal according to the exemplary embodiment of the present invention may include access (alternatively, connection configuration) preference order information for the system, the base station, the cell, or the AP according to multiple access methods preferred by the terminal or the user in addition to the information of the AP acquired by the terminal. Further, the preference order information may include access priority information to the wireless communication system, which is set by the user or set in the terminal by a separate method, or which the terminal accesses according to the measurement result. For example, the preference order information may include information regarding a preference order for a cellular system, the WLAN system, or a U-LTE system. In this case, the cellular system may be classified into a 2nd-generation (2G) mobile communication system (GSM or IS-95), a 3rd-generation (3G) mobile communication system (WCDMA, cdma2000, or the like), and a 4th-generation (4G) mobile communication (LTE or LTE-A). That is, the preference order information may include information on a priority of the system that the terminal preferentially desires to access when accessing the cellular system, the WLAN system, and the radio access system in another unlicensed band.

For example, the priority information may be configured as shown in Table 1 below, and preference information regarding the priority may be configured as shown in Table 2 below.

TABLE 1
Preference system mapping information configuration

| Preference system expression bit | Preference system |
|---|---|
| 000 | 3G WCDMA system |
| 001 | LTE/LTE-A macro cell |
| 010 | LTE/LTE-A small-sized cell |
| 011-100 | Reserved |
| 101 | Unlicensed band system |
| | (WLAN) |
| 110 | Unlicensed band system |
| | (U-LTE) |
| 111 | Reserved |

TABLE 2
Preference information transmitted by terminal

| Preference information | Remarks |
|---|---|
| 110 | Priority 1 |
| 010 | Priority 2 |
| 101 | Priority 3 |
| 001 | Priority 4 |

Referring to Table 1, the mapping information for the preference system is expressed as 3 bits, but may be configured as 4 bits or more or 2 bits. Information on a preference system mapped to an expression bit may be transferred to the terminal or the user may aware information by being broadcasted to the terminal through the system information, signaled through the dedicated control message, or embedded in a universal subscriber identification module (USIM) or at the time of the terminal registration.

Table 2 shows an example of the preference information transmitted by the terminal, and in this case, the priority may be represented in a descending order or an ascending order. For example, when preference information for the priority of Table 2 is transmitted, the base station represents that the preference order of the terminal is an unlicensed band system (U-LTE) 110, an LTE/LTE-A small-sized cell 010, an unlicensed band system (WLAN) 101, and an LTE/LTE-A macro cell 001 in the radio access or connection configuration for service connection of the terminal.

In the exemplary embodiment of the present invention, the preference information of the terminal may be transmitted in the form of the parameter that belongs to the control message configuring the feature group indicator (FGI) or transmitted through a separate control message (alternatively, a lower parameter in the control message) at the time of attempting the radio access or the connection configuration. Further, the preference information of the terminal may be transmitted even if the service is being provided according to the users selection and transmitted even through the control message (alternatively, the lower parameter in the control message) transmitted while the connection configuration is cancelled or during a control procedure of ending the radio access. Alternatively, the preference information of the terminal may be transmitted through a control message of a non-access stratum (NAS). In this case, the control message or the lower parameter in the control message may be configured in the form of an RRC control message which is layer 3 or a MAC control message which is layer 2.

In another exemplary embodiment of the present invention, the base station may provide the service to the terminal by using the WLAN AP, or the new AP without the consultation with the terminal. For example, the base station may recognize the need of providing a service to the terminal by using the AP and determine providing the service using the AP, while providing the service or connection for providing the service. In this case, as described in step S301 of FIG. 3, the base station may provide the WLAN AP information to the terminal and receive a report of the measurement result for the WLAN AP to which the information is provided from the terminal. Thereafter, the base station may determine whether to provide the service through the AP based on the measurement result reported by the terminal. Thereafter, when the service provided through the AP ends or the service need not be provided through the AP, the base station ends the service through the AP.

When the AP function of the terminal is inactivated, the base station may transmit the control message so as to activate the AP function of the terminal. When the service provided through the AP ends, the base station transmits a control message to inactivate the AP function of the terminal to the terminal to instruct the terminal to inactive the AP function. The activation/deactivation control message for the AP function of the terminal may be included in the RRC control message, the MAC control message, or the physical layer control message. Alternatively, in another exemplary embodiment of the present invention, the AP function of the terminal may be activated or inactivated, and may be activated or inactivated only by the AP measurement of the terminal. The activation or inactivation of the AP function of the terminal is to reduce power consumption of the terminal by preventing the terminal from unnecessarily performing the AP measurement. The activation/deactivation control of the AP function of the terminal by the base station may be set by the user and may be set at the time of initial registration of the terminal or subscribing to the service, or the base station may control the activation/deactivation of the AP function of the terminal according to a capability condition or a setting condition of the terminal.

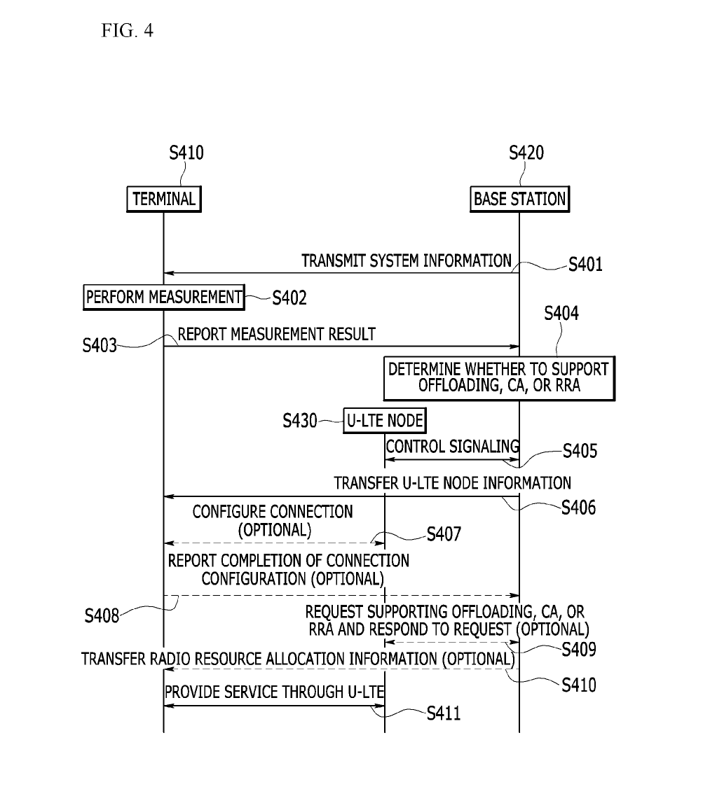

FIG. 4 is a flowchart illustrating a method for aggregating a radio resource according to another exemplary embodiment of the present invention.

The new AP may adopt a new radio access interface using the frequency in the unlicensed band based on the radio interface of the 3GPP LTE or LTE-A system. In the exemplary embodiment of the present invention, a system that provides a network node function according to the radio access interface in the unlicensed frequency band based on the LTE-LTE-A based radio access interface is referred to as unlicensed LTE (U-LTE).

In the U-LTE system, an LTE base station is set as a primary cell and a U-LTE node (the base station, the cell, the AP, or the new AP) in the unlicensed frequency band is set as a secondary cell. In the U-LTE system, when the RRA function is supported, the U-LTE node may not transmit the common information for efficient offloading. Further, the U-LTE node may not transmit the scheduling information for allocating the radio resource and the LTE base station as the primary cell adopts a cross scheduling technique to transmit radio resource allocation information of the U-LTE node. In this case, the terminal 410 may receive the radio resource allocation information on the U-LTE node 430 from the primary cell through the physical layer control channel or the physical layer shared channel.

First, the terminal receives the information on the U-LTE node and the measurement related information through the system information transmitted by the base station 420 (S401). In addition, the terminal performs measurement for the U-LTE node (S402) and determines whether to meet a triggering condition of the CA or RRA which may be serviced by using both the radio resources of the LTE node and the U-LTE node based on the measurement result or whether to meet the triggering condition for the data offloading which may be serviced by using the radio resource of the U-LTE node. The terminal may determine whether the data offloading, CA, or RRA is required through a separate condition. When the terminal determines that the data offloading, CA, or RRA is required, the terminal reports the measurement result for supporting the data offloading, CA, or RRA function to the base station according to a prior setup of the base station or an instruction by the base station (S403). In this case, the terminal may transmit the control message for requesting supporting the data offloading, CA, or RRA function together with reporting the measurement result for supporting the data offloading, CA, or RRA function through the U-LTE node.

The base station that receives the measurement result and the request for supporting the data offloading, CA, or RRA function determines whether to support the data offloading, CA, or RRA function (S404). In this case, the base station may exchange a control signaling message such as parameter setup for supporting the data offloading, CA, or RRA function with the U-LTE node by using a separate interface (S405). When the base station determines supporting the data offloading, CA, or RRA function, the base station may exchange control messages for supporting the data offloading, CA, or RRA function and a response to the supporting request with the U-LTE.

Thereafter, the base station that completes consultation with a U-LTE node transfers to the terminal information on the U-LTE node for supporting the data offloading, CA, or RRA function (S406). The terminal that receives the information on the U-LTE node for supporting the data offloading, CA, or RRA function from the base station performs a procedure for synchronization acquisition or connection configuration with a target U-LTE node according to information included in the control message received from the base station (S407). The terminal that completes the synchronization acquisition or the connection configuration with respect to the U-LTE node reports the completion for the synchronization acquisition or the connection configuration to the base station (S408). In this case, the step in which the terminal performs the synchronization acquisition or the connection configuration with respect to the target U-LTE node according to the information included in the control message and the step in which the terminal reports the completion of the synchronization acquisition or the connection configuration with respect to the U-LTE node may be selectively omitted. In addition, the base station may see that the terminal prepares for supporting the data offloading, CA, or RRA function through reporting the completion of the synchronization acquisition or the connection configuration for the U-LTE of the terminal or when a predetermined time elapses after transferring the information on the target U-LTE node to the terminal (alternatively, when a predetermined timer expires).

When the base station sees that the terminal completes preparing for the data offloading, CA, or RRA through the completion report of the terminal or based on the expiration of the timer, the base station requests supporting the data offloading, CA, or RRA function to the U-LTE (S409). In this case, the step in which the base station requests supporting the data offloading, CA, or RRA function to the U-LTE may be omitted.

Before the U-LTE node provides the service based on the data offloading, CA, or RRA function to the terminal, the base station may transmit radio allocation information between the U-LTE node and the terminal to the terminal (S410). That is, when only the U-LTE node (except for the LTE base station) transfers packet data to the terminal like the offloading or in the case of the CA or RRA in which the service is provided by using both the radio resources of the base station and the U-LTE node, the U-LTE node may not separately configure the physical layer control channel in which the radio resource allocation information is transmitted. In the exemplary embodiment of the present invention, instead, a separate control message (for example, a media access control (MAC) control message or a radio resource control (RRC) control message) including the radio resource allocation information of the U-LTE node may be transmitted to the terminal through the physical layer control channel or the physical layer shared channel of the base station. When the base station transmits the radio resource allocation information for the U-LTE node by using the physical layer control channel, an uplink control field (alternatively, feedback information) to verify whether the terminal successfully receives the scheduling information (that is, the radio resource allocation information for the U-LTE node) may be configured. That is, when the base station transmits the radio resource allocation information of the U-LTE node through the physical layer control channel, the terminal that successfully receives the radio resource allocation information of the U-LTE node may be configured to transmit the control field (alternatively, feedback information) on the uplink physical layer control channel to the base station. For example, a separate uplink control channel may be configured or the control field may be additionally configured in the uplink control channel in the related art, and the terminal may report whether to successfully receive the radio resource allocation information of the U-LTE node to the base station through the separate uplink control channel or the control field additionally configured in the uplink control channel.

Alternatively, when necessary, the U-LTE node may transmit the separate control message including the radio resource allocation information to the terminal not through the PDCCH but through the physical layer channel (for example, the PDSCH of the LTE system) transmitting data, or may transmit the radio resource allocation information to the terminal together with the data through the physical layer channel transmitting the data. In this case, when necessary, as an example, the PDCCH may not be configured in the U-LTE node or the PDCCH resource may be short.

Last, when the U-LTE node completes the connection configuration with the terminal, the U-LTE node may provide the service based on the data offloading, CA, or RRA function to the terminal (S411). In this case, the connection configuration between the terminal and the U-LTE node may be performed when the base station transfers the information of the target U-LTE node to the terminal, and in this case, the terminal may receive the service from the target U-LTE node without separate random access (RA).

Considerations for defining the radio access interface of the U-LTE node using the unlicensed frequency band will be described below. Unlike the LTE/LTE-A system using the permitted frequency, another wireless apparatus or another U-LTE apparatus having the same frequency band in the unlicensed band should not be influenced. For example, the strength of the transmission/reception signal of the apparatus constituting the base station, the cell, the AP, the small-sized base station, the terminal, or the wireless backhaul that follow the U-LTE radio access interface should not be more than a maximum signal strength required in the unlicensed band. Further, when the U-LTE apparatus attempts access for transmitting and receiving data or occupies the radio resource, if another wireless apparatus already makes the access or occupies the radio resource, the U-LTE apparatus should make the access or occupy the radio resource without influencing the other wireless apparatus. That is, like a scheme such as carrier sensing multiple access (CSMA) or carrier sensing multiple access/collision avoidance (CSMA/CA) based on the CS of the WLAN system, the apparatus (for example, the transmitting and receiving apparatus constituting the new AP, the small-sized base station, the terminal, or the wireless backhaul) of the U-LTE system should discover or monitor a radio channel before transmitting an access signal or a data signal. That is, a list before talk (LBT) or a robust co-existence mechanism (RCM) is required.

The apparatus (for example, the new AP, the base station, or the terminal that supports the U-LTE function) of the U-LTE system according to the exemplary embodiment of the present invention may perform search, listening, monitoring, sensing, or measurement (hereinafter referred to as a ‘discovery operation’) with a radio channel having a frequency to be used. The search, listening, monitoring, sensing, or measurement operation for the radio channel may be performed during a predetermined time interval and expressed by a time when the timer operates. Further, the U-LTE apparatus may acquire information (hereinafter referred to as ‘channel discovery information’) regarding the discovery operation of the radio channel of itself or receive the information from the base station of the LTE-LTE-A system.

When the U-LTE apparatus according to the exemplary embodiment of the present invention acquires the channel discovery information of itself, the U-LTE apparatus may verify whether the signal exists in the radio channel by performing the discovery operation for a predetermined time before transmitting the signal with respect to an operating frequency in the unlicensed band which is stored or known in advance. In this case, when another wireless apparatus or another U-LTE apparatus using the corresponding radio channel exists, the U-LTE apparatus verifies the strength of the signal discovered in the radio channel, the period of the signal, and the like to determine whether to use the radio channel. When another apparatus does not exist in the unlicensed frequency band in which the U-LTE apparatus according to the exemplary embodiment of the present invention performs the discovery operation or a condition that does not influence another apparatus is satisfied even though another apparatus exists, the U-LTE apparatus may transmit the signal. The U-LTE AP may transmit a common control signal such as the beacon, an advertisement signal, or system information, or attempt a service request.

The U-LTE apparatus according to another exemplary embodiment of the present invention may receive or acquire the channel discovery information for the frequency in the unlicensed band from the base station of the LTE/LTE-A system. When the terminal that supports the U-LTE function camps on a base station, the terminal that supports the U-LTE function may acquire the channel discovery information from the system information of the base station. In this case, the information on the operating frequency, the bandwidth, the apparatus identifier, the load status, the access priority, or the support function for the accessible U-LTE apparatus in the service area or on the periphery of the service area of the base station may be transmitted through a separate SIB or an SIB in the related art, to which an information element (IE) is added. Further, when the apparatus that supports the U-LTE function is configured to be connected with any other apparatus to receive the service, the information on the operating frequency, the bandwidth, the apparatus identifier, the load status, the access priority, or the support function for the accessible U-LTE apparatus may be transferred through a separate dedicated control message or acquired through the system information.

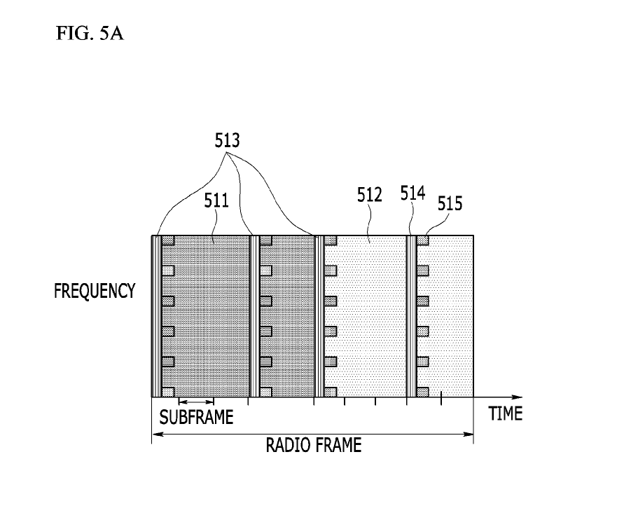

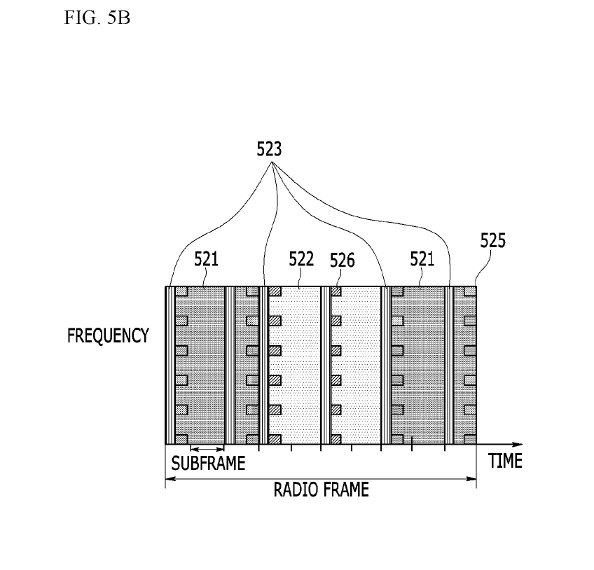

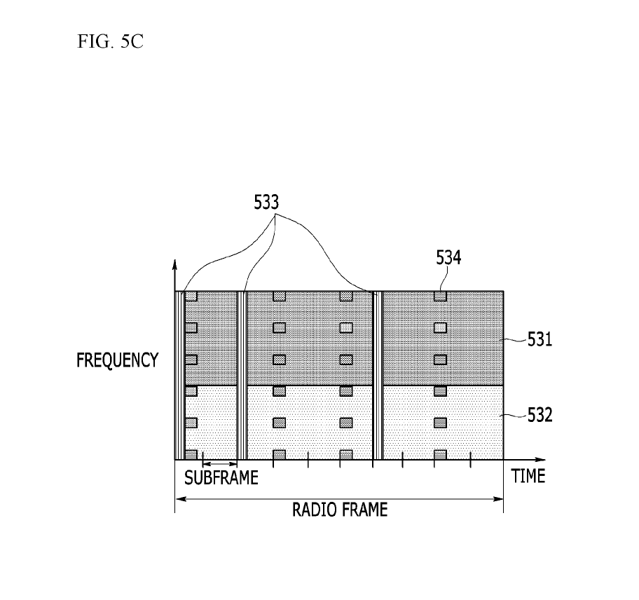

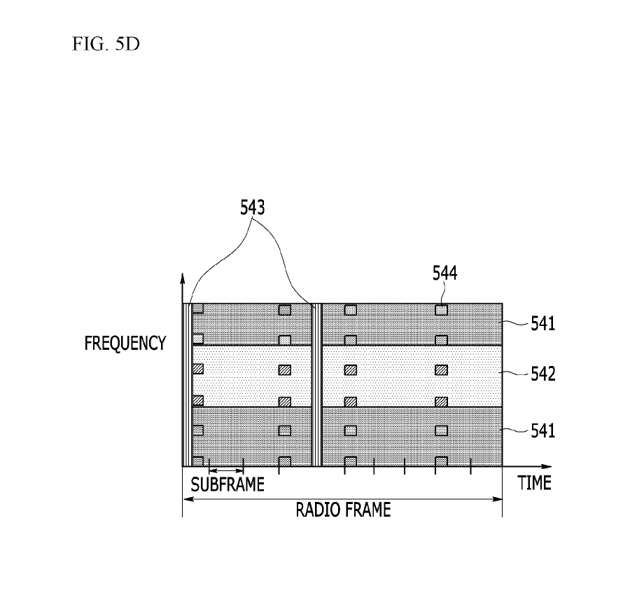

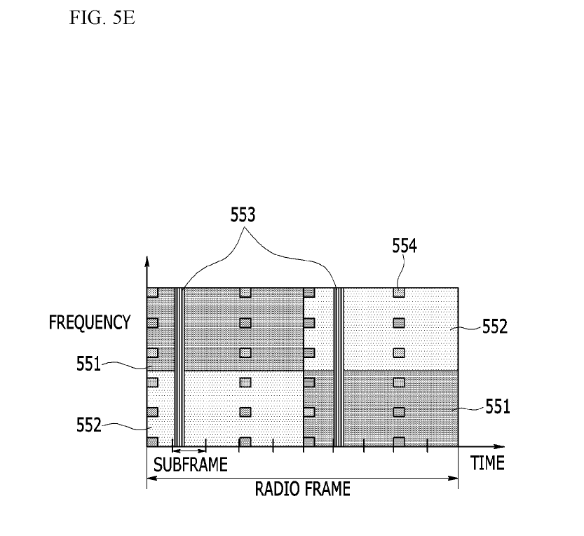

FIGS. 5A to 5E are diagrams illustrating a radio frame of a U-LTE system according to an exemplary embodiment of the present invention.

A U-LTE apparatus according to the exemplary embodiment of the present invention determines whether another apparatus of the wireless system or U-LTE apparatus exists around the U-LTE apparatus before transmitting a signal or data, in order to solve a co-existence problem. That is, the U-LTE apparatus may operate by dividing a radio resource for the U-LTE apparatus into a contention based area and a non-contention based area so as to efficiently perform a searching operation. For example, the U-LTE apparatus operates the searching operation in the contention based area, and when the radio resource can be occupied, initial access or random access or a connection request may be performed by using the radio resource in the contention based area. When the initial access or the connection request is completed, the U-LTE apparatus may receive a service by using the contention-based area and the non-contention-based area.

Referring to FIG. 5A to 5E, the radio resource for the U-LTE apparatus includes an area (contention-based area) acquired based on the contention and an area (non-contention-based area) allocated through scheduling. In addition, in FIG. 5A to 5E, one radio frame includes at least one sub-frame.

Referring to FIGS. 5A and 5B, the contention-based area and the non-contention-based area are divided on a time axis.

Referring to FIG. 5A, one radio frame includes one non-contention-based area 511 and one contention-based area 512. According to an exemplary embodiment of the present invention, one radio frame may include the same number of non-contention-based areas 511 and contention-based areas 512. The number of sub-frames included in the non-contention-based area 511 and the contention-based area 512 may be variably set for each radio frame. For example, when a length of the radio frame is 10 ms and a length of each sub-frame is 1 ms, the non-contention-based area 511 and the contention-based area 512 may include five sub-frames, respectively. Further, the non-contention-based area 511 may include seven sub-frames, and the contention-based area 512 may include three sub-frames. In addition, information on the number of sub-frames included in each area may be transferred to the U-LTE apparatus through system information, a beacon, an advertisement message, a dedicated control message, physical layer control channel information, or the like. In the exemplary embodiment of the present invention, the number of sub-frames included in each area may be dynamically changed by a radio frame unit, and even in this case, the setting information changed through the beacon, the advertisement message, or the physical layer control channel may be transferred.

When resources are allocated or managed in the sub-frame of 1 ms by a slot unit of 0.5 ms, the contention-based area and the non-contention-based area may be set to a slot unit.

Meanwhile, the physical layer control channel may be configured by the same format without division of the non-contention-based area 511 and the contention-based area 512. In this case, the fact that the physical layer control channel may be formed by the same format in each area may mean that a unit (for example, a control channel element (CCE)) a physical layer radio resource configuring the physical layer control channel, a configuration method (for example, a method of allocating a control channel radio resource through at least one CCE according to a size of control information) of the occupied radio resource, a determining method of an MCS, and the like may be equally applied for each physical layer control channel included in each area. Further, this may mean that a method of allocating a radio resource area by scheduling using a terminal identifier, a common identifier, or a terminal group identifier (for example, a multicast identifier and the like), or a method of masking control channel information through a scheduling identifier may be equally applied to the physical layer control channel included in each area.

The physical layer control channel means a channel of a physical layer for transmitting/receiving in the physical layer, a control parameter, a field, an indicator, or a bit for transferring packet data through a physical layer shared channel (for example, a PDSCH of an LTE system, a physical uplink shared channel (PUSCH), and the like), like a PDCCH, an ePDCCH, and a physical uplink control channel (PUCCH) of the LTE system.

The terminal identifier means a C-RNTI for transferring dynamic scheduling information, an SPS-RNTI for transferring semi-persisant scheduling (SPS) information, a transmit power control-physic uplink control channel-RNTI (TPC-PUCCH-RNTI) for transferring physical layer power control information, a TPC-PUSCH-RNTI, and the like.

The common identifier includes a paging-RNTI (P-RNTI) for scheduling of the radio resource transferring paging information, a system information-RNTI (SI-RNTI) for scheduling of the radio resource transferring system information, a random access-RNTI (RA-RNTI) for scheduling of the radio resource transferring a random access response or other control messages during random access, an M-RNTI (MBMS-RNTI) for informing a change of multimedia broadcast and multicast service (MBMS) related control information or MBMS multicast control channel (MCCH) information, and a contention resource-RNTI (CR-RNTI) for scheduling of the radio resource used by a plurality of terminals based on the contention.

According to another exemplary embodiment of the present invention, the physical layer control channels may be configured by different types for every non-contention-based area 511 and contention-based area 512. Referring to FIG. 5A, the non-contention-based area 511 includes three physical layer control channels 513, and the contention-based area 512 may include one physical layer control channel 514. In this case, in the physical layer included in each area (the non-contention-based area or the contention-based area), a unit (for example, a CCE), a physical layer radio resource configuring the physical layer control channel, a configuration method (for example, a method of allocating a control channel radio resource through at least one CCE according to a size of control information) of the occupied radio resource, an MCS method, and the like may be different from each other.

According to an exemplary embodiment of the present invention, a reference signal (RS) for channel quality measurement or interference measurement or a pilot symbol 515 may be equally used in the non-contention-based area and the contention-based area.

Referring to FIG. 5B, one radio frame includes two non-contention-based areas 521 and one contention-based area 522. Further, according to another exemplary embodiment of the present invention, unlike FIG. 5B, one radio frame may include one non-contention-based area and at least two contention-based areas, or one radio frame may include at least two non-contention-based areas and at least two contention-based areas. Like FIG. 5A, in the non-contention-based area and the contention-based area, physical layer control channels 523 may be configured by the same type or different types. Referring to FIG. 5B, the non-contention-based area 521 includes three physical layer control channels 523, and the contention-based area 522 may include one physical layer control channel 524.

The reference signals or the pilot symbols 525 and 526 may be differently set in each radio resource area. That is, referring to FIG. 5B, a first reference signal 525 included in the non-contention-based area 521 and a second reference signal 526 included in the contention-based area may be different from each other. In the reference signals 525 and 526 applied to the non-contention-based area 521 and the contention-based area 522 according to the exemplary embodiment of the present invention, a common reference signal or a reference signal for each terminal may be applied for channel quality measurement, interference measurement, or coherent demodulation. In the common reference signal, a position in the radio resource (a symbol position on a time axis of the sub-frame or the radio frame or a subcarrier position on a frequency axis), scramble code (alternatively, sequence) form and index, frequency of the reference signal, or the like may be set according to a node (an AP or a base station) to which the common reference signal is applied. In the reference signal for each terminal, the position in the radio resource, the scramble code form and index, the frequency of the reference signal, or the like may be set for each terminal. In the exemplary embodiment of the present invention, in the contention-based area, it may be effective in network operation for the reference signal for each terminal to be applied, and in the non-contention-based area, the common reference signal or the reference signal for each terminal may be applied. Alternatively, according to another exemplary embodiment of the present invention, in the contention-based area 522, a reference signal of the non-contention-based area 521 and a common reference signal or a reference signal for each terminal in which the position in the radio resource, the scramble code form and index, the frequency of the reference signal, or the like is different may be applied.

Referring to FIGS. 5C and 5D, the contention-based area and the non-contention-based area are divided on a frequency axis.

Referring to FIG. 5C, one radio frame includes one non-contention-based area 531 and one contention-based area 532. The number of subcarriers included in each area may be variably set by a radio frame unit. For example, referring to FIG. 5C, when a system bandwidth is 10 MHz and the number of subcarriers included in the system bandwidth is 80, the number of subcarriers included in the non-contention-based area and the contention-based area may be 40, respectively. Alternatively, according to another exemplary embodiment of the present invention, 60 subcarriers may be included in the non-contention-based area, and 20 subcarriers may be included in the contention-based area. In addition, in the non-contention-based area and the contention-based area, physical layer control channels 533 configured by the same format may be used. As described above, the physical layer control channel 533 may be configured according to a unit of a physical layer radio resource such as a CCE, a configuration method of an occupied radio resource, or a determining method of an MCS. Further, in the reference signal 534 applied to the non-contention-based area 531 and the contention-based area 532, a common reference signal may be applied or a reference signal for each terminal may be applied according to a purpose such as channel quality measurement, interference measurement, or coherent demodulation.

Referring to FIG. 5D, one radio frame includes two non-contention-based areas 541 and one contention-based area 542. Alternatively, one radio frame includes one non-contention-based area and two or more contention-based areas or two or more non-contention-based areas and contention-based areas, respectively. In addition, like FIG. 5C, in each area (non-contention-based area and contention-based area), a physical layer control channel 543 configured by the same format may be used. Further, a reference signal 544 for channel quality measurement, interference measurement, coherent demodulation, or the like may be differently set for each radio resource area. In the non-contention-based area 541, a common reference signal or a reference signal for each terminal may be applied according to a purpose of the reference signal such as channel quality measurement, interference measurement, or coherent demodulation. In the contention-based area, it is efficient in the operation that the reference signal for each terminal is applied, but the reference signal of the non-contention-based area, the position in the radio resource, the scramble code form and index, the frequency of the reference signal, or the like is different from the reference signal of the non-contention-based area, and a common reference signal or a reference signal for each terminal may be applied to the contention-based area.

Referring to FIG. 5E, the contention-based area 551 and the non-contention-based area 552 are divided on a time axis and a frequency axis. In FIG. 5E, in the operation of a reference signal 554 and a physical layer control channel 553, the methods described in FIGS. 5A to 5D may be selectively applied.

The non-contention-based area and the contention-based area according to the exemplary embodiment of the present invention illustrated in FIG. 5 are continuously allocated on the time axis or the frequency axis, but according to another exemplary embodiment of the present invention, radio resources of each area may also be discontinuously allocated on the time axis or the frequency axis. Further, one radio frame illustrated in FIG. 5 may include n non-contention-based areas and m contention-based areas. The position of the radio resource of the reference signal and the physical layer control channel illustrated in FIG. 5 is one example, and in the case of the physical layer control channel, some bandwidth periods may be discontinuously allocated to the physical layer control channel for any symbol period. Further, the physical layer control channel may be allocated for each sub-frame, or may be allocated on a cycle of a plurality of sub-frames according to a scheduling method. A node supporting a U-LTE function according to the exemplary embodiment of the present invention configures separate physical layer control information by a radio frame unit and may transmit physical layer control information by using the physical layer control channel for each radio frame. In this case, the physical layer control information may include setting information on a dynamic configuration ratio of the contention-based area and the non-contention-based area included in the radio frame. In this case, the physical layer control channel to which the physical layer control information of the radio frame unit is transmitted may be separately allocated to the foremost of each radio frame, or may be allocated to all or some of the physical layer control channels existing for each sub-frame.

The allocation of the radio resource described in FIGS. 5A to 5E may be performed according to a frequency division duplexing method or a time division duplexing method. In the case of a FDD scheme, in a configuration of a radio frame and a sub-frame of an downlink from a network node to a terminal, an uplink from the terminal to the network node, or a radio link (or a wireless link) for communication between the terminal and the network node, the non-contention-based area and the contention-based area may be allocated according to the method described in FIG. 5. Further, even in the case of a TDD scheme, the non-contention-based area and the contention-based area may be allocated to a part of the downlink sub-frame or the uplink sub-frame according to the method described in FIG. 5. For example, according to the TDD scheme, a plurality of sub-frames included in one radio frame are allocated as the downlink radio resource and the uplink radio resource, respectively, and the non-contention-based area and the contention-based area may be allocated to each sub-frame allocated by the downlink or the uplink.

In the U-LTE system, the network node may maintain connection for a service and allocate resources for transmitting a polling signal for a radio resource request or a resource allocation request (for example, scheduling request (SR)) signal for each U-LTE apparatus. That is, a U-LTE node may uniquely allocate a physical layer control channel or a separate physical layer radio resource for transmitting a polling signal or a resource allocation request signal for each U-LTE apparatus (alternatively, each U-LTE apparatus group) so as to transmit the polling signal or the resource allocation request signal when the connected U-LTE apparatus is required. In this case, the physical layer radio resource for transmitting the polling signal or the resource allocation request signal may be allocated in a process in which the U-LTE apparatus sets connection with the U-LTE node.

The U-LTE apparatus in the connection state may transmit the polling signal or the resource allocation request signal when a radio resource to transmit the signal to a network node or another U-LTE apparatus is required. The network node or another U-LTE apparatus receiving the polling signal or the resource allocation request signal transmits radio resource allocation information to the U-LTE apparatus transmitting the polling signal or the resource allocation request signal. The U-LTE apparatus recognizes a signal transmission intention of another U-LTE apparatus through the polling signal or the resource allocation request signal transmitted by another U-LTE apparatus to solve a co-existence problem. That is, in order to solve the co-existence problem with another wireless apparatus, the U-LTE apparatus may perform a sensing operation (for example, a CSMA/CA of a WiFi system), before transmitting the polling signal or the resource allocation request signal. Accordingly, the U-LTE apparatus may have a small effect on another wireless apparatus or another U-LTE apparatus and solve the co-existence problem.

According to the exemplary embodiment of the present invention, when the radio resource of the U-LTE system is divided and operated into the contention-based area and the non-contention-based area, the network node may allocate a radio resource in the non-contention-based area to the U-LTE apparatus in response to the polling signal or the resource allocation request signal transmitted by the U-LTE apparatus.

In the U-LTE system, in order to allocate the radio resource in the contention-based area or use the contention-based area by the U-LTE apparatus, the network node may allocate only some radio resources in the radio resource according to the U-LTE apparatus or according to an attribute of the service which is being provided to the U-LTE apparatus. Through a system information message or a separate dedicated control message for the U-LTE apparatus, the network node may transmit to the U-LTE apparatus priority information for each U-LTE apparatus, priority information according to a service attribute, or mapping (or indication) information of the radio resource in the contention-based region available according to the priority. In this case, the radio resource in the contention-based area indicated based on the priority of the U-LTE apparatus or the attribution of the provided service may have a mapping relationship according to each priority. In addition, the radio source in the contention-based area which is mapped in any priority or available may be used based on the contention by the accessible U-LTE apparatuses, and the accessible U-LTE apparatuses have the same priority.

Through the system information or the dedicated control message, the U-LTE apparatus receiving the priority information and the mapping information for the radio resource in the contention-based area may transmit required information by using only the radio resource in the contention-based area which is usable according to a priority of the U-LTE apparatus or an attribute of the provided service. Accordingly, the U-LTE apparatus in which connection with the network node of the U-LTE system is set may transmit packet data by using the radio resource in the contention-based area which is indicated based on a granted priority or an attribute of the provided service.

When the U-LTE apparatus transmits the packet data by using the contention-based area, the U-LTE apparatus may transmit identifier information allocated to the U-LTE apparatus. The network node (alternatively, another U-LTE apparatus) which successfully receives the packet data from the U-LTE apparatus through the radio resource in the contention-based area transmits the received identifier information to the U-LTE apparatus again to notify the U-LTE apparatus that the packet data is successfully received. In this case, the identifier of the U-LTE apparatus, as an identifier which any network node uniquely identifies the U-LTE apparatus, may include a scheduling identifier (e.g., C-RNTI), a temporary mobile subscriber identity (TMSI), an international mobile subscriber identity (IMSI), or an identifier which may uniquely identify the corresponding U-LTE apparatus in the system such as a MAC address.

In addition, when the packet data is transmitted as the radio resource in the contention-based area, a scheme where an MCS scheme and a transmission mode (TM) are assigned and a scheme where the MCS scheme and the TM are not assigned may be used. When the MCS scheme and the TM are assigned, information on the MCS scheme and the TM assigned for every contention-based area is transmitted. When the radio resource in the contention-based area is mapped according to a priority, different MCS schemes and TMs may be assigned for every radio resource in the contention-based area mapped according to each priority. The information on the MCS scheme and the TM in the contention-based area may be transmitted to the U-LTE apparatus through the system information or the dedicated control message. When the MCS scheme and the TM are not assigned, whenever the U-LTE apparatus transmits the packet data through the radio resource in the contention-based area, the U-LTE apparatus transmits information on the MCS scheme and the TM to the network node. In this case, the U-LTE apparatus may transmit the information on the MCS scheme and the TM together with the packet data or by using a separate physical layer radio resource (for example, an uplink physical layer control channel).

Even in the non-contention-based area, the resource allocation scheme may vary according to the priority of the U-LTE apparatus or the attribute of the proving service. In order to solve a co-existence problem in an unlicensed frequency band, from the viewpoint of resource allocation, when giving priority to fairness between the U-LTE apparatuses, there is a problem in that transmission speed of the system is lowered. Accordingly, with respect to a service attribute having high priority or the U-LTE apparatus, the radio resource may be continuously or discretely and repeatedly allocated for any period by periodically allocating or semi-persisant scheduling. However, with respect to a service attribute having low priority or the U-LTE apparatus, only a radio resource having the smallest size (minimum basic unit) may be allocated on the longest period available in the system when the resource allocation request of the U-LTE apparatus exists.

According to the exemplary embodiment of the present invention, the wireless apparatus in the unlicensed frequency band may determine whether another wireless system apparatus or a U-LTE apparatus exists therearound before transmitting any signal or data in order to avoid the co-existence problem. In this case, the U-LTE apparatus performs a ‘CS step’ of performing a searching operation such as researching, listening, monitoring, sensing, or measuring, and may perform a ‘communicating step’ of providing and receiving the service after overcoming the co-existence problem.

In the CS step, the U-LTE apparatus according to the exemplary embodiment of the present invention may sense whether the U-LTE apparatus exists therearound and determine whether the U-LTE apparatus occupies the radio resource in the unlicensed frequency bandwidth and transmits the signal. In the CS step, when the U-LTE apparatus occupies the radio resource in the unlicensed frequency bandwidth and transmits the signal, the U-LTE apparatus may perform initial access or connection request by using the radio resource in the contention-based area or the radio resource usable for the initial access or connection request in the U-LTE system. In this case, the U-LTE apparatus may perform the initial access or the connection request in the communication step.

Thereafter, the U-LTE apparatus may complete the searching operation for the peripheral U-LTE apparatus and perform the communication step. That is, the U-LTE apparatus may provide or receive the service through the communication step. The radio resource used in the communication step may be radio resource divided into the contention-based area or the non-contention-based area of FIG. 5.

The U-LTE apparatus according to the exemplary embodiment of the present invention may transmit a reference signal for the searching operation or the message in the initial access or the connection request by using the radio resource in the contention-based area. When the U-LTE apparatus transmits the reference signal for the searching operation by using the radio resource in the contention-based area, a period of the reference signal, a form (or type) of a signal sequence, a position of the radio resource (for example, a position of a subcarrier in the system-band or a symbol in the sub-frame), a transmission scheme (for example, an MCS scheme), scramble patterns, hopping patterns, or the like may be set to be suitable for an attribute of the contention-based area. That is, the radio resource in the contention-based area, the period of the reference signal, the form (or type) of a signal sequence, the position of the radio resource, the transmission scheme, the scramble patterns, the hopping patterns, or the like may be set as a network node-based parameter (for example, a cell specific parameter) or a terminal group based parameter, not a user equipment (UE)-based parameter (for example, a UE specific parameter). In this case, the U-LTE apparatus occupies the radio resource in the contention-based area and thus separate scheduling information for a physical layer control channel for transmitting a signal or a message is not required. In the case where the reference signal is transmitted through the radio resource in the contention-based area, the period of the reference signal, the form (or type) of a signal sequence, the position of the radio resource, the transmission scheme, the scramble patterns, the hopping patterns, or the like is per-configured in a system dimension or may be notified to the U-LTE apparatus before using the radio resource through common control information transmission such as system information transmission.

When the U-LTE apparatus according to the exemplary embodiment of the present invention transmits the signal through the radio resource in the non-contention-based area, scheduling information using a predetermined scheduling identifier is transferred, and the U-LTE apparatus may transmit only information related with the scheduling identifier through the radio resource assigned in the scheduling information. Accordingly, regardless of the downlink or the uplink, in the radio resource in the non-contention-based area, only information associated with a terminal (alternatively, a terminal group) or a scheduling identifier which is allowed the occupation through a physical layer control channel or a separate control signaling may be transmitted. In this case, the scheduling identifier may be an AP-RNTI, an SI-RNTI, a P-RNTI, an RA-RNTI, an M-RNTI, a C-RNTI, an SPS-RNTI, a C-RNTI, a TPC-PUCCH-RNTI, or a TPC-PUSCH-RNTI. In addition, when the scheduling information for the radio resource is transmitted to at least one terminal through the physical layer control channel, a separate scheduling identifier, for example, a multicast (MC)-RNTI, may be defined and used. In the exemplary embodiment of the present invention, radio resource allocation information for at least one terminal may be transmitted through the MC-RNTI which is a scheduling identifier for multicast, and a terminal or U-LTE apparatus which is allowable to share or use the MC-RNTI acquires the scheduling information to provide or receive the service through the radio resource assigned in the scheduling information.

Further, according to an exemplary embodiment of the present invention, for configuration or allocation of the radio resource in the contention-based area, a contention resource (CR)-RNTI may be set as a scheduling identifier for transmitting resource allocation information in the physical layer control channel. The radio resource in the contention-based area may be notified to the U-LTE apparatus by pre-configuration, and the radio resource in the contention-based area may be assigned as allocation information of the radio resource (for example, a position or a size of the allocated radio resource, a transmission scheme including modulation and encoding, or a transmission form (for example, an antenna configuration, a CA configuration, a transmission carrier identifier, or a resource allocation purpose), or the like), which is transmitted to the physical layer control channel by using the CR-RNTI. Further, in the entire system or any network node, at least one MC-RNTI or CR-RNTI may be configured and used.

Meanwhile, in the exemplary embodiment of the present invention, the operation of the CS step does not need to influence another U-LTE apparatus and another wireless apparatus in the same unlicensed frequency band in addition to an initial transmitting and receiving operation of the U-LTE apparatus. In the operation in the CS step, a priority for an LTE AP or a base station may be granted. In this case, the priority may be identified through an AP identifier, a primary synchronization signal (PSS), a secondary synchronization signal (SSS), or a separate reference signal, a signal sequence, a form, or a scramble index (for example, a scramble code or a sequence index) of a physical channel symbol. In the CS step, the AP having low priority may concede the occupy of the radio resource when the AP having high priority is detected in the searching operation of determining whether another wireless system apparatus or U-LTE apparatus exists in order to avoid the co-existence problem. In this case, while the service is provided to the AP having low priority or when the AP having low priority provides the service, the service is terminated and the occupation of the radio resource is conceded.

When power of the U-LTE apparatus is turned on, in order to minimize an effect on another wireless apparatus (for example, a WLAN apparatus), the U-LTE apparatus may operate according to operational procedure and reference such as energy detection (ED), CSMA/CA, or CSMA/CD (collision detection) defined in a WLAN standard. That is, the U-LTE apparatus may be operated according to the operational procedure and reference defined in the U-LTE system, after verifying that there is no effect on the WLAN apparatus. In order to verify the effect on other peripheral equipment when the power of the U-LTE apparatus is turned on, the U-LTE apparatus may use system information that is periodically transmitted. That is, the U-LTE node may broadcast the system information which is the common control information to a service area in a periodically defined sub-frame, and the turned-on U-LTE apparatus detects energy of the radio resource (for example, a specific subcarrier or a specific subcarrier group) transmitted by the system information in a specific subframe in which the U-LTE node or the U-LTE apparatus transmits the system information (energy detection) or measures the reference signal of the radio resource in which the system information is transmitted to verify whether the co-existence problem occurs.

Thereafter, the U-LTE apparatus may complete the operational procedure when the power is turned on, verify that there is no effect on another wireless apparatus, continuously or discontinuously transmit the scheduling information of the occupied radio resource, transmit a physical layer signal notifying of the occupation of the radio resource, or occupy the radio resource which may provide or receive the service without an effect on another apparatus by avoiding the co-existence problem through the configuration information transmission in the non-contention-based area. The scheduling information on the non-contention-based area may be transmitted to a terminal or a terminal group through the physical layer control channel. In this case, the AP-RNTI, the SI-RNTI, the P-RNTI, the RA-RNTI, the M-RNTI, the C-RNTI, the SPS-RNTI, the C-RNTI, the MC-RNTI, and the like described above may be used as the scheduling identifier. The scheduling information may include information such as a position or a size of the allocated radio resource, a transmission scheme including modulation and encoding, and a transmission form, and may be transmitted through a physical layer control channel or a physical layer shared channel from only the transmission of the physical layer control channel.

The scheduling information in the U-LTE system means radio resource allocation information transmitted to the U-LTE apparatus. The radio resource allocation information may be configured by parameters for the position or the size of the allocated radio resource, the transmission scheme including modulation and encoding, the transmission form, the resource allocation purpose, or the like. The radio resource allocation information for any U-LTE apparatus may be transmitted for every sub-frame, periodically transmitted for every predetermined sub-frame interval, or aperiodically transmitted in any sub-frame. In an existing LTE/LTE-A system, the scheduling information is basically transmitted as the radio resource allocation information for one sub-frame. In the U-LTE system according to the exemplary embodiment of the present invention, the scheduling information may be transmitted as the radio resource allocation information for a plurality of sub-frames. The radio resource allocation information according to the exemplary embodiment of the present invention may include allocation starting radio frame and allocation starting sub-frame information, allocation ending radio frame and allocation ending sub-frame information, or allocation interval information of a radio frame and sub-frame unit. When the radio resource allocation information for a plurality of sub-frames or a plurality of radio frames is transmitted, the U-LTE apparatus may transmit feedback information informing that the radio resource allocation information is successfully received. In this case, the feedback information may be transmitted by using specific field information of the physical layer control channel and may be transmitted through a MAC control message or an RRC control message.

In order to overcome the co-existence problem, the U-LTE apparatus according to the exemplary embodiment of the present invention may recognize the service in the corresponding frequency band through existence of the physical layer control channel in the searching operation of determining where another wireless system apparatus or the U-LTE apparatus exists. In the U-LTE system according to the exemplary embodiment of the present invention, existence of the physical layer control channel, a format of the physical layer control channel, configuration information (for example, a size of the physical layer control channel, a transmission format, information of the next physical layer control channel, and the like) may be transmitted by using some radio resources of the physical layer control channel. In this case, the format or the configuration information of the physical layer control channel may be transmitted through a separately defined area in some radio resources of the radio resources for the physical layer control channel or the radio resource of the physical layer. Further, the format or the configuration information of the physical layer control channel may be applied with a fixed modulation and encoding scheme, transmitted by a slot (a plurality of symbols) or sub-frame unit, or transmitted by a plurality of slots, a sub-frame, or a radio frame unit. The U-LTE apparatus according to the exemplary embodiment of the present invention may recognize that another wireless apparatus provides or receives the service in the corresponding frequency band by searching or monitoring the format or the configuration information of the physical layer control channel. In the system dimension, when the format or the configuration information of the physical layer control channel is not defined or applied, the U-LTE system may recognize that another wireless apparatus provides or receives the service in the corresponding frequency band by searching and monitoring periodically transmitted common control information or aperiodically transmitted common information (for example, a random access message, a paging message, an AP-related common control message transmitted through the RA-RNTI, the P-RNTI, the AP-RNTI, or the like) like the system information or the beacon information.

According to the exemplary embodiment of the present invention, the U-LTE apparatus may recognize that another wireless apparatus using the radio resource of the sub-frame or the radio frame exists by using a reference signal transmitted in the sub-frame or the radio frame, masking applied to a pilot symbol, a code or a sequence for scrambling, or the like. In the U-LTE system according to the exemplary embodiment of the present invention, a specific-shaped scramble code or sequence and a specific-shaped masking code or sequence are applied to all or fixed partial areas of the reference signal or the signal configuring the pilot symbol to implicitly or explicitly express that the wireless apparatus using the radio resource of the sub-frame or the radio frame exists.

Accordingly, the U-LTE apparatus according to the exemplary embodiment of the present invention to attempt to access or start transmission in the unlicensed frequency bandwidth may minimize an effect on another wireless apparatus before the access attempt or the transmission start through a receiving signal intensity of the reference signal or the pilot symbol or through information informing whether another wireless apparatus exists. In this case, the U-LTE apparatus according to the exemplary embodiment of the present invention may selectively combine the above-described methods.

Meanwhile, in the U-LTE system according to the exemplary embodiment of the present invention, the reference signal may be differently configured according to a use purpose. First, the reference signal is required in order to obtain downlink synchronization between the network node and the terminal and verify the physical layer identifier of the network node. Further, in order to measure channel quality between the U-LTE apparatuses, the reference signal is required, and in order to estimate a position of the U-LTE apparatus or assist in the position measurement, the reference signal is required. Further, in order to support an on/off operation of the network node for energy saving, the reference signal is required.

As the reference signal (hereinafter referred to as a ‘synchronization reference signal’) for acquiring the downlink synchronization between the network node and the terminal and verify the physical layer identifier (for example, a physical cell identifier (PCI)), a PSS or an SSS of the LTE/LTE-A system is used or a new reference signal may be introduced. The synchronization reference signal needs to be periodically transmitted, and it is efficient in frequency scalability supporting to attributively use a partial band of a system bandwidth of the network node for transmission. When the PSS/SSS for the existing LTE/LTE-A system is used as the synchronization reference signal for the U-LTE apparatus, since a terminal rather than the U-LTE terminal has no information on the masking or scrambling sequence, the terminal may not recognize the U-LTE apparatus. However, the U-LTE apparatus may verify the masking or scrambling sequence in addition to the PSS/SSS and then verify the physical layer synchronization and the physical layer identifier of the network node by the same method as the existing LTE/LTE-A system. A method of verifying the masking or scrambling sequence in addition to the PSS/SSS transmitted by the network node of the U-LTE system is to remove the masking or scrambling sequence and detect an original PSS/SSS by performing de-masking or descrambling using the masking or scrambling sequence of the PSS/SSS by the U-LTE apparatus receiving the synchronization reference signal. If necessary, in order to expand the physical layer identifier which may be configured by only the PSS/SSS, the masking or scrambling sequence may be used. That is, the method is a method of configuring the physical layer identifier expressed by only the PSS/SSS as the physical layer identifier of the U-LTE apparatus by using the masking or scrambling sequence of the PSS/SSS in addition to the PSS/SSS. For example, in the existing LTE system, the physical layer identifier may be defined as in the following Equation 1.

N_{ID}^{cell}=3N_{ID}⁽¹⁾+N_{ID}⁽²⁾ (Equation 1)

In Equation 1, N_{ID}⁽²⁾ is determined by the PSS and may have a value of 0 to 2, and N_{ID}⁽²⁾ is determined by the SSS and may have a value of 0 to 167. Accordingly, the number of physical layer identifiers may be 504 (0 to 503, 9 bits).

The U-LTE system according to the exemplary embodiment of the present invention may use bits adding the masking or scrambling sequence to the physical layer identifier expressed by the PSS/SSS as the physical layer identifier in order to express 504 or more physical layer identifiers. For example, the physical layer identifier of the U-LTE system may the same as the following Equation 2.

N_{ID}^{cell}=3N_{ID}⁽¹⁾+N_{ID}⁽²⁾+N_{ID}⁽³⁾ (Equation 2)

In Equation 2, N_{ID}⁽³⁾ is bits determined from the masking or scrambling sequence. Accordingly, the physical layer identifier of the U-LTE system may be extended by a range of bits determined from the masking or scrambling sequence. The PSS/SSS of the LTE/LTE-A system may be extended like Equation 2. An existing terminal (legacy terminal) detects the physical layer identifier by only the PSS/SSS, and the terminal after the extending technique of the physical layer identifier is introduced may determine N_{ID}⁽³⁾ from a new reference signal or a separate signal and detect the physical layer identifier through Equation 2.

In the U-LTE system according to another exemplary embodiment of the present invention, a new synchronization reference signal for the U-LTE apparatus may be configured. A new synchronization reference signal according to another exemplary embodiment of the present invention may be periodically transmitted through some limited bands (for example, some subcarriers around the center subcarrier of the system bandwidth) like the PSS/SSS of the LTE system. In addition, the U-LTE apparatus may detect the synchronization acquisition of the physical layer or the physical layer identifier by using a new synchronization reference signal of the U-LTE system and the PSS/SSS of the LTE system (transmitted the same as the LTE system). In this case, the N_{ID}⁽³⁾ may be determined from the new synchronization reference signal of the U-LTE system.

The PSS/SSS of the U-LTE system and the new synchronization reference signal are transmitted at an interval of 5 ms through six resource blocks (RB) positioned at the center of the system bandwidth like the PSS/SSS transmission of the LTE system and may be repeatedly transmitted every 40 ms. In this case, one RB may include 12 subcarriers. In addition, the new synchronization reference signal of the U-LTE system may be mapped in a different radio resource from the radio resource transmitted by the PSS/SSS of the U-LTE system. The PSS/SSS and the new synchronization reference signal of the U-LTE system may have a different transmission period as the PSS/SSS of the LTE system if necessary.

According to another exemplary embodiment of the present invention, the reference signal of the existing LTE/LTE-A system is corrected to be used as the synchronization reference signal of the U-LTE system. The corrected synchronization reference signal of the U-LTE system may be transmitted and extended as described above.

The reference signal for measuring the channel quality between the U-LTE apparatuses may become a node specific RS in the network node of the U-LTE system and a UE specific RS in the U-LTE terminal. The node specific RS may be transmitted for each sub-frame in the radio frame or in the specific subcarrier and symbol of a predetermined sub-frame so that all the terminals are commonly received. The node specific RS may be scrambled by using different scramble sequences for every network node, and each terminal receiving the node specific RS may distinguish the network node transmitting the node specific RS by using the scramble sequence. The UE specific RS is a reference signal configured for each terminal in the connection state for providing the service. Accordingly, the U-LTE network node may transmit configuration information including the UE specific RS to the terminal through the dedicated control message in the connection setting process of the terminal. The U-LTE apparatus may measure the channel quality of a wireless period by using the node specific RS or the UE specific RS and report a measurement result of the channel quality to the network node according to a measurement report configuration condition in the connection configuration control message. In this case, the report may be periodically transmitted through the physical layer control channel like a PUCCH channel quality indicator (CQI) or a PUCCH channel status indicator (CSI).

In the U-LTE system, the network node may transmit an occupied reference signal informing that the radio resource of the sub-frame or the radio frame is occupied, by using all or some subcarriers included in the system bandwidth and the specific symbol. In this case, since the network node (alternatively, the U-LTE apparatus) of the U-LTE system may notify the occupied state of the radio resource to another wireless apparatus, the occupied reference signal may become a measure for solving the co-existence problem. In the exemplary embodiment of the present invention, the U-LTE apparatus or the wireless apparatus may occupy the sub-frame or the radio frame by detecting the occupied reference signal and determine whether the network node or the U-LTE apparatus of the U-LTE system to transmit the packet data exists. Accordingly, in the U-LTE system, when the occupied reference signal does not exist or the occupancy of the radio resource is allowed because the measurement value of the reference signal is smaller than the reference value, the U-LTE apparatus may transmit the packet data by using the corresponding radio resource. Alternatively, when the occupied reference signal exists or the measurement value of the reference signal is larger than the reference value, the U-LTE apparatus may have an access restriction on the radio resource or may not transmit the packet data through the corresponding radio resource. In this case, the scramble sequence or the masking sequence is applied to the occupied reference signal and thus information of an attribute of the U-LTE apparatus during occupying and an occupying period (for example, the number of sub-frames or radio frames) may be expressed.

When the network node of the U-LTE system according to the exemplary embodiment of the present invention operates by dividing the radio resource into the non-contention-based area and the contention-based area, and the network node ensures the non-contention-based area without transmitting/receiving the packet data for providing the service to transmit the occupied reference signal corresponding to the non-contention-based area. That is, the network node may maintain the radio resource configuration for the non-contention-based area through the transmission of the occupied reference signal. Further, the network node according to the exemplary embodiment of the present invention may inform that the radio resource is allocated for a predetermined time through the scheduling information (alternatively, radio resource allocation information) informing that the radio resource in the non-contention-based area is occupied. In this case, the allocation time of the radio resource may be set by a continuous or discrete method through the parameter setting.

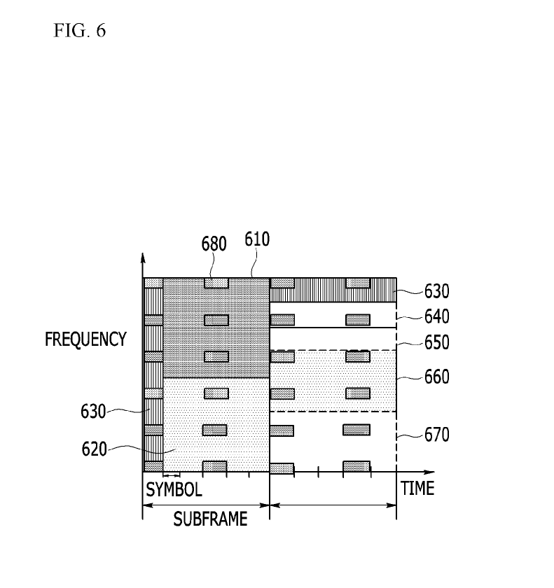

FIG. 6 is a diagram illustrating a radio frame of a U-LTE system according to another exemplary embodiment of the present invention.

In the resource allocation of the U-LTE system according to the exemplary embodiment of the present invention, the resources may be allocated to the U-LTE apparatus in multiples of a predetermined minimum constitution unit. For example, the minimum constitution unit of the physical layer resource block (PRB) may be set to the number of subcarriers constituting a basic PRB 640. That is, when 12 subcarrier included in one subframe are set as the basic PRB 640, one or more U-LTE apparatuses occupy the physical layer resource block constituted by the unit of one or more basic PRBs 640 to transmit the packet data. In this case, when one or more U-LTE apparatuses use the physical layer resource in one subframe, the physical layer resources used in the respective U-LTE apparatuses should not collide or overlap with each other. In the exemplary embodiment of the present invention, when the physical layer resource in the subframe is segmented into the basic PRB 640 units and a any U-LTE apparatus occupies the physical layer resource, the collision may be avoided even though a plurality of U-LTE apparatuses occupy the radio resource of one subframe by limiting a start point.

Referring to FIG. 6, when the physical layer radio resource is scheduled by the unit of the subframe, one subframe may include a physical layer control channel 630 in which physical layer control information is transmitted and a reference signal transmitting area 680 for channel quality measurement, interference measurement, and transmission of an occupation reference signal. The physical layer control channel 630 according to the exemplary embodiment of the present invention may be allocated by the unit of a symbol or a subcarrier in the subframe. That is, when the physical layer control channel 630 is applied to a downlink or uplink (downlink/uplink subframe in the TDD scheme) radio resource of a U-LTE system, the physical layer control channel 630 may be allocated to one or more symbols or one or more subframes.

A subframe may include a non-contention based area 610 and a contention-based area 620 like a first subframe. In a second subframe of FIG. 6, the basic RPB 640 includes one or more subcarriers and one or more symbols, and the number of subcarriers or symbols included in the basic PRB 640 may be determined according to an attribute of a service or a capability of the U-LTE apparatus. In the second subframe of FIG. 6, access resources segmented by using the basic PRB 640 as the unit may be segmented into access resource 1 650, access resource 2 660, and access resource 3 670 by using the basic PRB as the unit. In the exemplary embodiment of the present invention, it is described that the access resources of the subframe are segmented into three resources, but the number of access resources included in one subframe may vary. In addition, resource segment information regarding the access resources (that is, physical layer radio resources) may be set according to a priority of the U-LTE apparatus (alternatively, a U-LTE apparatus group) and a priority of a service which is being provided. Further, a method for limiting the radio resource or the access resource according to the priority of the U-LTE apparatus (alternatively, the U-LTE apparatus group) and the priority of the service which is being provided may be set by the unit of the subframe. The radio resources which may be used or occupied according to the set priority may be segmented by the unit of the subframe. For example, when one radio frame includes 10 subframes (index 0 to index 9), priority #1 is granted to subframes #0, 4, and 9, priority #2 is granted to subframes #1, 2, 5, and 6, and priority #3 may be granted to subframes #3, 7, and 8. In this case, the U-LTE apparatuses having the same priority are determined to use the same transmission time or radio resource, and the priority may be used to control inter-U-LTE apparatus interference, adjust a collision probability or a load status, and the like.

The configuration information (alternatively, segmentation information of the access resource) of the radio resource using the basic PRB 640 as the unit as a common control message may be transmitted through the system information (alternatively, a beacon) or transmitted to the U-LTE apparatus (alternatively, the U-LTE apparatus group) by using the dedicated control message. For dynamic resource allocation, the radio resource allocation information according to the priority, and the configuration information of the radio resource or the access resource segmentation information using the basic PRB 640, may be transmitted through the radio resource of the physical layer channel (for example, the physical layer control channel or physical layer data transmission channel) every scheduling period or when necessary. The dynamic scheduling information may be transmitted in a previous subframe of a subframe to which the dynamic scheduling information is applied. For example, scheduling information transmitted in an n-th subframe may be scheduling information regarding an n+1, n+2, . . . , n+(m−1), or n+m-th subframe.

A U-LTE terminal that receives a control message including the configuration information of the radio resource or the segmentation information of the access resource may transmit packet data by using a physical layer resource which the U-LTE terminal may access (alternatively, use).

According to another exemplary embodiment of the present invention, the access resources included in the subframe may be segmented according to a separate reference previously set in a network node of the U-LTE system. In this case, the segmentation information of the access resource may be transmitted to the U-LTE apparatus through control signaling in which the common control message is used or using the dedicated control message like the system information (alternatively, a beacon). When the priorities are set for the segmented access resources, mapping information of the priority may also be transmitted to the U-LTE apparatus through the control signaling or the dedicated control message. Alternatively, for efficient configuration of the control message, the mapping information between the segmented access resources and the priorities is not transmitted and the priorities may be implicitly expressed by using a list order (for example, the descending order or ascending order) of the control message constituting the segmentation information of the access resource.

In the U-LTE system according to the exemplary embodiment of the present invention may set the attribute of the service that the U-LTE apparatus may transmit according to the capability of the U-LTE apparatus, the service attribute, or the quality of the radio channel, the size of the packet data, a modulation and coding level in transmission, an antenna setting scheme such as multiple input multiple output (MIMO), or the like, or an accessible physical layer resource block. In addition, a setting parameter including the physical layer resource block which the U-LTE apparatus may use to transmit the packet data may be notified to the U-LTE apparatus by the method such as the common control message, the dedicated control message, or the scheduling information in consideration of the quality of the radio channel. The U-LTE system may segment the quality of the radio channel into 5 levels and set a radio channel quality reference for each level. For example, the U-LTE system may set an upperlimit value and a lowerlimit value of a radio channel quality evaluating index such as RSRQ having a mapping relationship with each level of the radio channel quality.

When the quality levels of level 1 (good) to level 5 (bad) are provided with respect to the radio quality, if the radio channel quality estimated by a U-LTE apparatus is constituted by 5 levels, packet data of a service having an attribute in which a required QoS is low may be transmitted with a smallest packet data size (for example, a size transmittable as the basic PRB unit) which is permitted in the U-LTE system. Further, in this case, as a U-LTE modulation and coding level, a highest robust level permitted by the system may be permitted or a specific modulation and coding level may be adopted. Further, in terms of the radio resource, the transmission of the packet data may be limited to the physical layer resource area that may transmit only the basic PRB unit or to a separately specified physical layer resource area.

When the radio channel quality estimated by a U-LTE apparatus is at level 1, transmission of the packet data for all types of services permitted by the system may be permitted without a limit in service attribute, and the U-LTE apparatus may select and transmit without a limit in size of the packet data or the size of the transmitted packet data may be maximally permitted. Further, the modulation or coding level may also be selected and determined by the U-LTE apparatus.

That is, according to the exemplary embodiment of the present invention, the attribute of the service, the size of the packet, the modulation and coding level, a usable physical layer resource area, the size of the physical layer resource block, a transmission pattern (for example, a transmission mode (TM) applied to the physical layer of the LTE/LTE-A system), and the like which may be adopted at each level of the radio quality may be set and parameterized. In addition, the network node of the U-LTE system transfers setting parameter information depending on the radio channel quality to the U-LTE apparatus to allow the U-LTE apparatus to perform a prior setup or notify the setting parameter information to the U-LTE apparatus whenever necessary. The U-LTE apparatus that receives the configuration parameter information may determine the capability of the U-LTE apparatus, the service attribute, and the modulation and coding level to be applied to the packet data by using the configuration parameter information.

The U-LTE apparatus according to the exemplary embodiment of the present invention may transmit information such as a stand-by time required until the U-LTE apparatus transmits the packet data, the number of attempt times, or an average stand-by (or waiting) time together with the packet data. The network node of the U-LTE system according to the exemplary embodiment of the present invention may apply a stand-by time until transmitting the packet data, the number of attempt times, or average stand-by information collected by the U-LTE apparatus to setting of the physical layer resource block according to the priority, setting of the contention-based area or non-contention based area, and the like. Further, a plurality of network nodes of the U-LTE system may exchange information such as the setting parameter depending on the radio channel quality and the stand-by time collected in the U-LTE apparatus, and control the inter-network node load status.

When the mobile communication base station is set as a primary node and the U-LTE node that operates in the unlicensed frequency band is set as a secondary node, the mobile communication base station may transmit the resource allocation information for the U-LTE apparatus or the U-LTE apparatus may transmit the scheduling information to the base station. In this case, the base station may perform scheduling or resource management so as to prevent a collision with or interference in another U-LTE apparatus by considering the scheduling information received from the U-LTE apparatus. In order to secure transmission reliability of the radio section between the U-LTE apparatuses using the frequency in the unlicensed band, a radio resource for communication between the U-LTE apparatuses may be allocated consecutively or allocated discretely but repeatedly during some duration. When the radio resource is allocated consecutively or allocated discretely but repeatedly during the duration, a receiving unit combines consecutively received packets or repeatedly received packets to increase receiving success rate of the packet data. In the U-LTE system according to the exemplary embodiment of the present invention, when the radio resources are consecutively allocated or a plurality of discrete radio resources are allocated, repeated transmission is instructed in the scheduling information or display information regarding whether the radio resources are repeatedly transmitted is transmitted by using the physical layer field to improve service quality and system performance. For example, when a field indicating whether the scheduling information is repeatedly transmitted is ‘repeated transmission’ (for example, when a control field is 1 bit, the field is set to ‘1’), the U-LTE apparatus may repeatedly transmit the same packet through the indicated radio resource, and when the field indicating whether the scheduling information is repeatedly transmitted is ‘not repeated transmission’ (for example, when the control field is 1 bit, the field is set to ‘0’), the U-LTE apparatus may transmit respective different packets through the indicated radio resource. When the U-LTE apparatus may selectively set the indicator regarding whether the radio resource is repeated transmitted by using the physical layer control field, the U-LTE apparatus to which the plurality of radio resources are allocated by a temporally consecutive or discrete method through the scheduling information may display whether the radio resource is repeatedly transmitted through the indicator depending on the situation and repeatedly transmit the same packet data or different packet data at each transmission time according to the displayed information.

According to the exemplary embodiment of the present invention, ACK/NACK feedback information for notifying successful reception of the packet for each transmission time or ACK/NACK feedback information may be used to increase efficiency of resource utilization. After the packet data is transmitted through the consecutively or discretely allocated radio resources, a transmitting unit that receives the ACK for notifying the successful reception from the receiving unit stops repeated transmission to reduce power consumption. In this case, when the allocated radio resource remains, the transmitting unit transmits other data through the remaining radio resource or allocates the radio resource to other U-LTE apparatus to improve radio resource utilization.

When the ACK/NACK feedback is not used, a radio resource for transmitting the ACK/NACK feedback is not required, and as a result, the transmitting unit just performs the repeated transmission. In this case, allocation of the radio resource for retransmission is not required and a CS step for overcoming a coexistence problem at the time of acquiring the retransmission radio resource is not required.

In the U-LTE system according to another exemplary embodiment of the present invention, a retransmission scheme using the ACK/NACK feedback of the physical layer, such as a hybrid automatic repeat request (HARQ), may be applied. In order to apply the HARQ retransmission to the U-LTE system using the frequency in the unlicensed band, the radio resource allocation for the retransmission needs also to be considered. That is, in the mobile communication system using the licensed frequency band, the radio resource for the HARQ retransmission may be fixedly allocated or dynamically allocated as necessary, but in the U-LTE system, it is difficult to fixedly allocate or dynamically allocate the radio resource for transmitting the ACK/NACK feedback information and the retransmitted data due to the coexistence problem.

To this end, after the LTE base station is set as the primary node and the U-LTE node in the unlicensed frequency band is set as the secondary node, the LTE base station transmits the radio resource allocation information of the U-LTE. In addition, the ACK/NACK feedback information regarding the packet data transmitted through the U-LTE radio resource may be transmitted through the LTE radio resource. In this case, in the exemplary embodiment of the present invention, a reception failure of the packet data transmitted through the U-LTE radio resource may not be recognized as receiving the NACK feedback information, and when the ACK feedback information is not received within a predetermined time (for example, a time during waiting for receiving the ACK/NACK feedback information after the packet data is transmitted), the reception failure is recognized. Further, in another exemplary embodiment of the present invention, the reception success of the packet data transmitted through the U-LTE radio resource is not recognized as receiving the ACK feedback information, and when there is no NACK feedback information within a predetermined time, the reception success is recognized.

In the case of the reception failure, the retransmission of the packet data may be performed through the LTE radio resource or the U-LTE radio resource. When the packet data transmitted through the U-LTE radio resource is retransmitted, the radio resource is not fixedly allocated, and when the reception failure is recognized, a predetermined time interval (a retransmission time window) is set to perform the retransmission within the predetermined time interval. In this case, the time interval for the retransmission may mean until a timer set in the retransmission time interval ends after the need of the retransmission is recognized through the ACK/NACK feedback. That is, when the reception failure of the packet data transmitted through the U-LTE radio resource occurs and the retransmission need is recognized, the radio resource for retransmitting the packet data is allocated and a retransmission procedure is performed before the timer set in the retransmission time interval ends. In this case, when the reception failure occurs even with respect to the retransmitted packet data, the retransmission may be performed again according to the retransmission parameter and the retransmission procedure. In this case, the maximum number of retransmission times is set and the number of retransmission times is thus limited for the U-LTE system, and a time interval for the maximum number of retransmission times may be separately set. Alternatively, when the timer for the maximum number of retransmission times ends, even though the number of retransmission times does not reach the maximum number of retransmission times, the retransmission may not be performed.

Hereinafter, for when scheduling for the downlink transmission to the U-LTE apparatus in the secondary node (a U-LTE node and the like) is included in scheduling information on the primary node (the LTE base station and the like), retransmission will be described.

First, for initial transmission, the primary node transmits scheduling information on a downlink radio resource of the U-LTE apparatus. In this case, the scheduling information may include uplink scheduling information.

In addition, the U-LTE node transmits packet data to the U-LTE apparatus according to the scheduling information received from the primary node. In this case, the primary node may notify the scheduling information on the U-LTE apparatus before a transmission time of the packet data to the U-LTE node, or notify the scheduling information according to a transmission time of the packet data.

The U-LTE apparatus may receive the packet data transmitted through the downlink radio resource of the U-LTE system in the -LTE node and transmit an ACK or NACK feedback informing whether the U-LTE apparatus receives the packet data or not to the U-LTE node. In this case, the ACK/NACK feedback information may be transmitted through the U-LTE uplink radio resource or the LTE uplink radio resource. When the U-LTE apparatus transmits feedback informing of a reception failure, a timer related with a time period for setting for the retransmission starts and a counter value of the maximum retransmission number may be set.

In the exemplary embodiment of the present invention, when the ACK/NACK feedback is transmitted through the LTE radio resource, a radio resource for transmitting the uplink control information having a mapping relationship with the downlink radio resource to which the scheduling information of the U-LTE apparatus is transmitted is used, or a radio resource set for only the control message for supporting the secondary node (the U-LTE node) in the uplink of the LTE system is used.

In another exemplary embodiment of the present invention, when the ACK/NACK feedback is transmitted through the U-LTE radio resource, the radio resource (for example, the uplink radio resource for transmitting the ACK/NACK feedback or the packet data) of the U-LTE system disclosed in the scheduling information transmitted by the primary node may be used.

Thereafter, the U-LTE node receiving the ACK/NACK feedback from the U-LTE apparatus or waiting the reception of the ACK/NACK feedback starts a retransmission procedure when recognizing the reception failure. In this case, the timer configured for retransmission starts and the counter value may be set.

The primary node (the LTE node) transmits the scheduling information including U-LTE radio resource information for retransmission in the retransmission time window to the secondary node (the U-LTE node), and retransmits the packet data to the U-LTE apparatus through the scheduled radio resource. In this case, the scheduling information on the radio resource of the U-LTE system may be notified from the primary node to the U-LTE node and the U-LTE apparatus, and the U-LTE node may retransmit the packet data based on the radio resource of the received scheduling information from the primary node.

Thereafter, the U-LTE apparatus receives the retransmission packet transmitted through the U-LTE downlink radio resource according to the scheduling information. The retransmission procedure described above may be repeated until the maximum number of retransmissions is reached or until the timer set for the maximum retransmission time period ends.

Hereinafter, according to another exemplary embodiment of the present invention, in the case of transmitting the scheduling information in the secondary node (the U-LTE node and the like) and transmitting the packet data from the secondary node to the U-LTE apparatus, retransmission will be described.

First, for initial transmission, the U-LTE node transmits scheduling information on a downlink radio resource of the U-LTE system to the U-LTE apparatus. In this case, the scheduling information may include uplink scheduling information. In addition, the U-LTE node transmits the packet data according to the scheduling information. In this case, the U-LTE node may transmit the packet data together with the scheduling information.

The U-LTE apparatus receives the packet data transmitted trough the U-LTE downlink radio resource by the U-LTE node, and may transmit ACK/NACK feedback information to the U-LTE uplink radio resource. The U-LTE apparatus starts a timer for a predetermined time period for retransmission in the case of reception failure and sets a counter value.

In another exemplary embodiment of the present invention, the ACK/NACK feedback may be transmitted through the U-LTE radio resource included in the scheduling information transmitted from the U-LTE node.

In another exemplary embodiment of the present invention, the ACK/NACK feedback may be transmitted by using the uplink radio resource obtained based on the contention like the random access procedure by the U-LTE apparatus, the uplink radio resource obtained by using the predetermined radio resource for the resource request, or the radio resource separately set for the ACK/NACK feedback.

When the U-LTE node recognizes the reception failure of the U-LTE apparatus, the U-LTE node starts the retransmission procedure of the packet data. In this case, the timer configured for retransmission starts and the retransmission number may be counted.

The U-LTE node transmits the scheduling information including U-LTE radio resource information for retransmission in the retransmission time window, and retransmits the packet data through the scheduled radio resource. In this case, the scheduling information of the U-LTE node and the packet data transmission may depend on the above-described method.

The U-LTE apparatus receives the packet data retransmitted through the U-LTE downlink radio resource according to the received scheduling information. The retransmission of the packet data may be repeated until the maximum number of retransmissions is reached or until the timer of the maximum retransmission time period ends.

Hereinafter, according to another exemplary embodiment of the present invention, for when the primary node schedules the radio resource of the U-LTE system and the U-LTE apparatus performs uplink transmission to the U-LTE node, retransmission will be described.

For initial transmission, the primary node transmits scheduling information on the uplink radio resource of the U-LTE system. In addition, the U-LTE apparatus transmits packet data to the U-LTE node through the uplink radio resource of the scheduling information received from the primary node. In this case, the uplink scheduling information for the U-LTE apparatus may be transferred to the U-LTE node from the primary node.

The U-LTE node receiving the packet data transmitted by the U-LTE apparatus may transmit the ACK/NACK feedback to the U-LTE apparatus. In this case, the ACK/NACK feedback may be transmitted through the downlink radio resource of the LTE system or the U-LTE system. The U-LTE apparatus starts a timer for a predetermined time period for retransmission when the reception of the packet data is failed, and sets a counter value. Further, the scheduling information of the uplink radio resource of the U-LTE system for retransmission may be transmitted together with the ACK/NACK feedback. In this case, the ACK/NACK feedback and the scheduling information of the uplink radio resource may be configured by separate messages.

In the exemplary embodiment of the present invention, when the U-LTE node transmits the ACK/NACK feedback to the U-LTE apparatus by using the downlink radio resource of the LTE system, the U-LTE node may transmit the ACK/NACK feedback through a separate physical hybrid-ARQ indicator channel (PHICH) for supporting the U-LTE apparatus, a radio resource for transmitting the downlink control information having a mapping relationship with the uplink radio resource included in the scheduling information transmitted by the LTE node, or a radio resource set for only the control message for supporting the secondary node in the downlink of the LTE system.

In another exemplary embodiment of the present invention, when the U-LTE node transmits the ACK/NACK feedback to the U-LTE apparatus by using the radio resource of the LTE system, the U-LTE node may transmit the ACK/NACK feedback through a U-LTE downlink control channel having a mapping relationship with the uplink radio resource included in the scheduling information transmitted by the LTE node, a downlink radio resource provided separately for the ACK/NACK feedback transmission in the U-LTE downlink, or a U-LTE downlink radio resource for transmitting the packet data.

The U-LTE apparatus receiving the ACK/NACK feedback from the U-LTE node recognizes the reception failure of the packet data. In this case, the U-LTE apparatus starts the timer set for retransmission and sets a counter value. In addition, when the scheduling information of the U-LTE uplink radio resource for retransmission is not transmitted together with the ACK/NACK feedback, the LTE node transmits the scheduling information on the U-LTE uplink radio resource for retransmission in the retransmission time window, and the U-LTE apparatus may retransmit the packet data through the uplink radio resource according to the received scheduling information.

Thereafter, the U-LTE node receives the packet data retransmitted by the U-LTE apparatus. The retransmission of the packet data may be repeated until the number of retransmissions reaches the maximum number of retransmissions or until the timer set for the maximum retransmission time period ends.

Hereinafter, according to another exemplary embodiment of the present invention, when the secondary node transmits scheduling information on the radio resource of the U-LTE system and the U-LTE apparatus performs uplink transmission to the U-LTE node, retransmission will be described.

For initial transmission, the secondary node transmits scheduling information on the uplink radio resource of the U-LTE system. In this case, the scheduling information may include downlink scheduling information. In addition, the U-LTE apparatus transmits packet data to the U-LTE node based on the uplink radio resource of the scheduling information received from the secondary node.

Thereafter, the U-LTE node receives the packet data from the U-LTE apparatus and may transmit the ACK/NACK feedback to the U-LTE apparatus. When the reception of the packet data is failed, the U-LTE node starts a timer related to the time period set for retransmission and sets a counter value. In this case, in the U-LTE node, the scheduling information on the -LTE uplink radio resource for retransmission may be transmitted to the U-LTE apparatus in addition to the ACK/NACK transmitted to the U-LTE apparatus. However, the ACK/NACK feedback information and the U-LTE uplink radio resource scheduling information may be configured by separate messages.

Meanwhile, the U-LTE node may transmit the ACK/NACK feedback by using the U-LTE radio resource. In this case, the U-LTE node may transmit the ACK/NACK feedback through a U-LTE downlink control channel having a mapping relationship with the U-LTE uplink radio resource, a downlink radio resource provided separately for the ACK/NACK feedback transmission in the U-LTE downlink radio resource, or a U-LTE downlink radio resource for the packet data transmission.

The U-LTE apparatus receiving the ACK/NACK feedback from the U-LTE node recognizes the reception failure of the packet data. In this case, the U-LTE apparatus starts the timer set for retransmission and may set a counter value. In addition, when the scheduling information of the U-LTE uplink radio resource for retransmission is not transmitted together with the ACK/NACK feedback, the U-LTE node transmits the scheduling information on the U-LTE uplink radio resource for retransmission in the retransmission time window to the U-LTE apparatus, and the U-LTE apparatus may retransmit the packet data through the uplink radio resource according to the received scheduling information.

Thereafter, the U-LTE node receives the packet data retransmitted by the U-LTE apparatus. The retransmission of the packet data may be repeated until the number of retransmissions reaches the maximum number of retransmissions or until the timer set for the maximum retransmission time period ends.

In the U-LTE system according to the exemplary embodiment of the present invention, a consideration of a back-off operation is required for an access procedure of attempting occupying or requesting the radio resource. The back-off operation is required to reduce the collision of the U-LTE apparatuses when the plurality of U-LTE apparatuses perform the access procedure to the radio resource. For example, when a random number is generated within a window in which a back-off value is set and the set timer ends based on the generated random number, one U-LTE apparatus may perform the access procedure to the radio resource. Therefore, when the back-off value is large, a collision probability of the U-LTE apparatus may be low, but a latency of the access procedure may increase. On the contrary, when the back-off value is small, the latency of the access procedure may decrease, but the collision probability of the U-LTE apparatus may increase.

In the U-LTE system according to the exemplary embodiment of the present invention, the back-off value is set according to the quality of the radio channel or the strength of the received signal, according to the number of access attempt times of the U-LTE apparatus to the U-LTE node, or according to the load status of the U-LTE node to variably operate the back-off operation.

For example, when the back-off value is set according to the quality of the radio channel or the strength of the received signal, in the case where the quality of the radio channel is good, the back-off value may be set to a minimum value or the radio resource may be accessed without the back-off. In addition, in the case where the quality of the radio channel is bad, the back-off value may be set to a relatively large value and the access to the radio resource may be attempted after a back-off counter ends. However, in this case, since only the U-LTE apparatus having the good quality of the radio channel may monopolize the radio resource, an equity problem may occur.

In the U-LTE system according to another exemplary embodiment of the present invention, the back-off value may vary according to an occupation attribute of the uplink resource together with the quality of the radio channel or the strength of the received signal. That is, even though the quality of the radio channel is good, the service attribute and the like are additionally considered, and as a result, an access authority to the radio resource may be granted. For example, when the quality of the radio channel is good and the continuous occupation is permitted, a permission fact is notified to the U-LTE apparatus through the scheduling information, and thereafter the back-off value may be set to the minimum value or the access procedure may operate without the back-off. However, when continuous occupation of a specific U-LTE apparatus is not permitted according to the service attribute even though the quality of the radio channel is good, the relatively large back-off value may be set and the U-LTE apparatus may attempt accessing the radio resource after the back-off counter ends.

In the U-LTE system according to another exemplary embodiment of the present invention, the back-off value may be variably set according the number of access attempt times of the U-LTE apparatus to the U-LTE node or according to the load status of the U-LTE node. That is, when the number of access attempt times of the U-LTE apparatus to the U-LTE node is large or the load of the U-LTE node is large, the relatively large back-off value may be set, and when the number of access attempt times of the U-LTE apparatus to the U-LTE node is small or the load of the U-LTE node is small, the relatively small back-off value may be set. In this case, reference values for the number of access times and the load status may be separately set and the U-LTE node may set the back-off value according to each reference value. The set back-off value may be transferred to the U-LTE apparatus in the form of the system information, the separate common control message, the dedicated control message, or the control message of the MAC layer. The variable setting methods of the back-off value described above may be selectively combined with each other, and when the radio resource is not accessed but the control information or the packet data is transmitted, the back-off may not be applied.

In the exemplary embodiment of the present invention, when the back-off value is variably set according to the quality of the radio channel (alternatively, the strength of the received signal), the service attribute (QoS or QCI), a terminal capability, the capability of the U-LTE node, the number of access attempt times, or the load status of the U-LTE node, back-off information (alternatively, a back-off list) is configured by the common control message to be transmitted through the system information, the RRC control message, or the control message of the MAC layer or transmitted through the dedicated control message. In this case, the back-off information is graded based on the quality of the radio channel, the service attribute, the terminal capability, the capability of the U-LTE node, the number of access attempt times, or the load status of the U-LTE node, and a back-off value corresponding to each grade may be applied to the U-LTE system. Thereafter, in the U-LTE system, the U-LTE node or the U-LTE apparatus that attempts occupying the radio resource may access the radio resource after verifying the back-off information.

According to the exemplary embodiment of the present invention, when the service is provided through the U-LTE node, a mobility status of the terminal may be considered. For example, when the terminal moves at a high speed, the service may be provided through the LTE system, and when the terminal moves at the low speed or is stationary, the service may be provided through the U-LTE node. To this end, a ‘mobility status condition’ of the terminal that may receive the service through the U-LTE node may be defined and the defined mobility status condition may be notified to the terminal in the form of the system information or the dedicated control message.

In the exemplary embodiment of the present invention, the mobility status condition of the terminal may be classified into level 1 in which the terminal moves fastest to level 5 in which the terminal moves slowest. In addition, level 4 may be set as a reference value of the mobility status condition, and when the mobility status of the terminal is at level 4 or 5 of the mobility status condition, the terminal may receive the service from the U-LTE node. In this case, level 5 may represent a stop status of the terminal and a grade representing the stop status of the terminal may be separately set. The terminal according to the exemplary embodiment of the present invention measures a mobility status thereof, and when the terminal moves at the low speed or is stationary, the terminal may transmit control information for reporting the mobility status thereof to the LTE node or the U-LTE node. In this case, the control information for reporting the ‘stationary status’ of the terminal may be transmitted as the MAC control message or the control message of the RRC layer.

The mobility status of the terminal may be measured by using a speed of the terminal, a status change degree of the radio channel quality, or the strength of an interference signal. In addition, in the U-LTE system according to the exemplary embodiment of the present invention, the LTE node or the U-LTE node receives the report regarding the mobility status measured by the terminal from the terminal or estimates the mobility status of the terminal by using the uplink signal to verify the mobility status of the terminal. In addition, it may be determined whether a specific terminal accesses the U-LTE node to receive the service through determining whether the mobility status of the terminal meets the mobility status condition. That is, the U-LTE node and the like may provide the service through the U-LTE node to the terminal when the mobility status of the terminal meets the mobility status condition.

In the exemplary embodiment of the present invention, the network node may be in the form of the base station, the cell, the AP, or the new AP that performs a terminating function of the wireless network. In addition, in the structure of the radio frame according to the exemplary embodiment of the present invention described through FIGS. 5 and 6, the non-contention based area, the contention based area, or the subcarrier such as the access resource, or the like are contiguous, but this is a logical concept and the subcarriers of the actual physical layer resource block may be allocated consecutively or discretely.

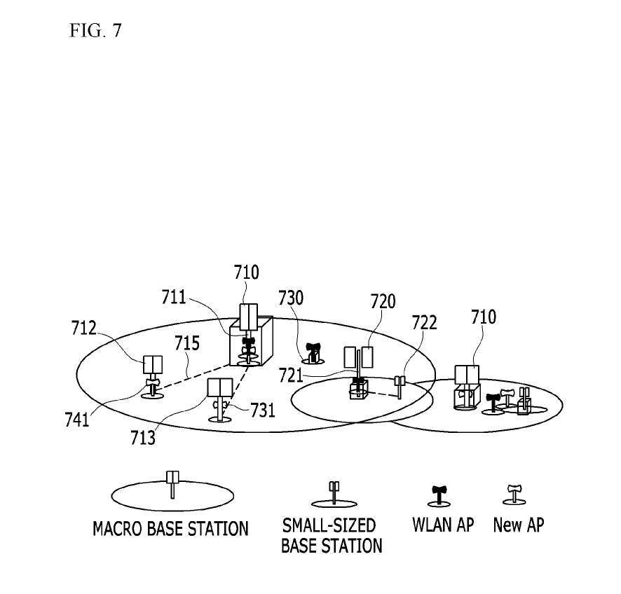

FIG. 7 is a diagram illustrating a wireless network according to another exemplary embodiment of the present invention.

Service switching (for example, an offloading or service continuity function) between the U-LTE node or the WLAN node, and the base station (macro base station) of a mobile communication and concurrent service (for example, a plurality of connection functions or RRA) method may be applied to all radio access apparatuses that operate in an unlicensed band frequency. For example, the RRA may provide the service to a subscriber apparatus by using the radio resources of the respective systems together through signaling between the U-LTE node or the WLAN node and the macro base station.

The RRA may be efficient when the U-LTE node or the WLAN node and the macro base station are co-located. The RRA may be more efficient when the U-LTE node or the WLAN node and the macro base station are divided into a macro node RU that takes charge of processing an analog signal including an RF function and a macro node DU that takes charge of processing a digital signal including a baseband function. When the U-LTE node or the WLAN node is co-located with the macro base station or when the macro node RU and the U-LTE node or the WLAN node are co-located, a signal strength of the U-LTE node or the WLAN node may be estimated through a signal strength of the macro base station. Accordingly, the RRA may be triggered without reporting the signal strength of the U-LTE node or the WLAN node.

Referring to FIG. 7, a macro base station 710 may be connected with a macro node DU 711 and macro node RUs 712 and 713, the macro node DU 711 may be installed at the same position as the macro base station 710, and the macro node RUs 712 and 713a may be installed at a different position (one point in a service area of the macro base station) from the macro base station 710. The macro base station 710 may be positioned together with the macro node DU 711, the RU of the WLAN AP, and the RU of the new AP. Further, a WLAN AP 730 in which the DU and the RU are combined or a small-sized base station 720 may be positioned in the service area of the macro base station 710. The macro node RUs 712 and 713 may be positioned together with an RU 731 of the WLAN AP and an RU 741 of the new AP.

In FIG. 7, the macro node DU 711 connected to the macro base station 710 may include a macro DU function that takes charge of processing a digital signal to correspond to the macro nodes RUs 712 and 713, a DU function of the WLAN AP that takes charge of processing the digital signal to correspond to the RU 731 of the WLAN AP, and a DU function of the U-LTE node that takes charge of processing the digital signal to correspond to the RU 741 of the new AP. That is, the macro node DU 711 may perform the DU function corresponding to each system according to a system type (that is, the mobile communication system, the WLAN system, or the U-LTE system) of the RU connected to the macro node DU 711.

In addition, the small-sized base station 720 may be connected with a small-sized node DU 721 and a small-sized node RU 722, the small-sized node DU 721 may be connected to the small-sized base station 720, and the small-sized node RU 722 may be installed at a different position from the small-sized base station 720. Referring to FIG. 7, a DU/RU interface 715 may be configured in a wired or wireless method, which connects the macro node DU 711 and the macro node RUs 712 and 713, and the small-sized node DU 721 and the small-sized node RU 722.

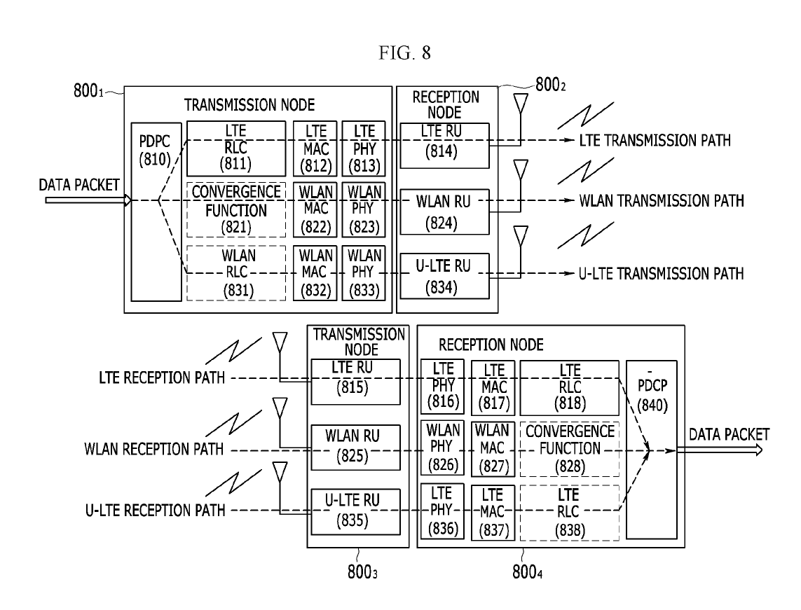

FIG. 8 is a diagram illustrating a protocol stack of a U-LTE system according to an exemplary embodiment of the present invention.

Referring to FIG. 8, the packet data may be transmitted through a bearer, and a transmission node DU 800₁ and a transmission node RU 800₂ may support the LTE system, the WLAN system, and the U-LTE system using the frequency in the unlicensed band. In this case, the macro node DU or the small-sized node DU may become the transmission node DU 800₁ or a reception node RU 800₃. In addition, the macro node RU or the small-sized node RU may become an LTE RU included in a transmission node RU 800₂ and an LTE RU included in a reception node RU 800₄ of FIG. 8. Further, the WLAN AP RU illustrated in FIG. 7 may become a WLAN RU included in the transmission node RU 800₂ and a WLAN RU included in the reception node RU 800₄ of FIG. 8 and the new AP RU illustrated in FIG. 7 may correspond to a U-LTE RU included in the transmission node RU 800₂ and a U-LTE RU included in the reception node RU 800₄ of FIG. 8. Therefore, that the mobile communication base station, the WLAN AP, and the U-LTE node exist at the same position may represent a case in which WLAN AP DU and RU or a DU and an RU of the U-LTE node are co-located or the base station and the WLAN AP RU or the RU of the RU of the U-LTE node are co-located.

In the transmission apparatus according to the exemplary embodiment of the present invention, a service data unit (SDU) of a radio protocol layer means packet data transferred from a higher layer. Further, a packet data unit (PDU) includes the packet data (one or more SDUs or segmented SDUs) transferred from the higher layer and header information or control information specialized to any radio protocol layer. That is, a radio protocol layer attaches the header information or control information specialized to the radio protocol layer to the packet data of the higher layer to generate the PDU and transfer the generated PDU to a lower radio protocol layer. In this case, the header information or control information may include a sequence number (SN), a data/control (D/C) field, segmentation information, or a channel identifier.

The reception apparatus according to the exemplary embodiment of the present invention separates the header information or the control information from the PDU received from the lower radio protocol layer of the transmission apparatus to extract the SDU, and reassembles the packet data from the SDU to transfer the configured packet data to the higher layer.

For example, in the MAC layer, a MAC PDU includes a MAC header, a MAC SDU (larger than 0), a MAC control element (larger than 0), or padding information. The MAC SDU and the MAC header have variable sizes and the MAC SDU as a byte unit may be included in the MAC PDU sequentially from a first bit.

Further, in a radio link control (RLC) layer, an RLC SDU or segmented RLC SDUs are mapped to a data field of an RLC PDU. The RLC layer does not add a header or adds another format of header according to a transmission mode (a transparent mode (TM), an unacknowledged mode (UM), or an acknowledge mode (AM)) to configure the RLC PDU. In the case of the TM, the RLC configures the RLC PDU with one SDU without adding the header. In the case of the UM, the RLC adds a header in which fields such as framing information (FI), a length indicator (LI), the SN, extension (E), and the like are selectively combined to configure the RLC PDU. In the case of the AM, the RLC adds a header in which fields such as data/control (D/C), a re-segmentation flag (RF), a polling bit (P), the FI, the SN, a last segment flag (LSF), a segment offset (SO), and the LI are selectively combined to configure the RLC PDU. In the case of the AM, the RLC layer of the reception apparatus transfers the SN information on the received RLC PDU to the transmission apparatus to perform an ARQ function to perform retransmission of the RLC PDU. After the retransmission of the RLC PDU using the ARQ, the RLC of the reception apparatus may transfer a STATUS PDU for the retransmitted RLC PDU by using fields such as the D/C, a control PDU type (CPT), an ACK_SN, a NACK_SN, an SO start (SOstart), and an SO end (SOend). In this case, whether the retransmitted RLC PDU is successfully received may be notified through the STATUS PDU. Thereafter, the RLC layer of the transmission apparatus may recognize the RLC PDU and retransmit the RLC PDU again even after the retransmission by using the STATUS PDU received from the reception apparatus.

The transmission node DU 800₁ includes a plurality of blocks that take charge of processing a digital signal of the LTE system, the WLAN system, and the U-LTE system using the frequency in the unlicensed band. A packet data convergence protocol (PDCP) layer 810 of the transmission node DU 800₁ transfers packet data of a bearer received from the higher layer to an LTE RLC layer 811, a WLAN RLC layer 821, or a U-LTE RLC layer 831 which is a lower protocol layer of the system, which participates in the RRA. In this case, the base station determines one of an LTE transmission path, a WLAN transmission path, and a U-LTE transmission path as a transmission path of the packet data, and the PDCP layer 810 transfers the packet data through the determined transmission path. Therefore, a scheduler of the base station may determine the transmission path of the packet data that belongs to the bearer, and the PDCP layer 810 may transfer the packet data to the LTE RLC layer 811 when being allocated the LTE radio resource, transfer the packet data to the WLAN RLC layer 821 when being allocated the WLAN radio resource, and transfer the packet data to the U-LTE RLC layer 831 when being allocated the U-LTE radio resource.

When the packet data received through the PDCP 810 is transferred through the LTE transmission path, the packet data is transferred to the LTE RLC layer 811, an LTE MAC layer 812, and an LTE PHY layer 813 sequentially in the transmission node DU 800₁. The LTE RLC layer 811 may perform the retransmission function of the RLC SDU and may transfer the packet data to the LTE MAC layer 812 according to the reception order from the PDCP 810. The LTE MAC layer 812 may perform a HARQ function and perform a processing function for a transport channel to packet data to the LTE PHY layer 813. The LTE PHY layer 813 may perform digital signal processing of the physical layer, which includes coding or modulation of the MAC PDU (alternatively, a transport block (TrBK)) received from the LTE MAC layer 812.

When the packet data received through the PDCP 810 is transferred through the WLAN transmission path, the packet data may be sequentially transferred to a convergence function layer 821, a WLAN MAC layer 822, and a WLAN PHY layer 823 in the transmission node DU 800₁. That is, the transmission node DU 800₁ according to the exemplary embodiment of the present invention may include the convergence function block for an interface between the LTE-based PDCP layer 810 and the WLAN MAC layer 822 on the WLAN transmission path. In this case, the convergence function block 821 may convert the PDCP PDU of the LTE system according to the MAC SDU of the WLAN system. That is, the convergence function block 821 receives the packet data from the PDCP 810 to convert the packet data to suit a protocol structure of the WLAN system, and thereafter transfer the converted packet data to the WLAN MAC layer 822. For example, the convergence function block 821 may map the PDCP PDU to the data field according to a frame format of the WLAN MAC layer 822 and add header information adopted in the MAC layer 822 of the WLAN system to the PDCP PDU mapped to the data field.

The WLAN MAC layer 822 may transfer the packet data to the WLAN PHY layer 823 by performing the WLAN MAC function. The WLAN PHY layer 823 may perform the digital signal processing in the physical layer of the WLAN system, which includes the coding or the modulation.

When the packet data received through the PDCP layer 810 is transferred through the U-LTE transmission path, the packet data may be sequentially transferred to the U-LTE RLC layer 831, a U-LTE MAC layer 832, and a U-LTE PHY layer 833 in the transmission node DU 800₁. The U-LTE RLC layer 831 may configure the transferred PDCP PDU with the RLC PDU and transfer the RLC PDU to the U-LTE MAC layer 832. However, the U-LTE RLC layer 831 may be omitted in the U-LTE transmission path, and in this case, the packet data may be directly transferred to the U-LTE MAC layer 832 from the PDCP layer 810. The U-LTE MAC layer 832 may transfer the packet data to the U-LTE PHY layer 833 by performing the processing function for the transport channel. In addition, the U-LTE PHY layer 833 may perform the digital signal processing of the physical layer, which includes the coding or modulation of the MAC PDU (alternatively, the TrBK) received from the U-LTE MAC layer 832 which is the higher layer.

The transmission node DU 800₁ according to the exemplary embodiment of the present invention may use one memory buffer for packet data of one bearer. Each layer included in the transmission node DU 800₁ may perform signal processing of the packet data by using an address of the memory buffer, and does not actually read or write data in the memory buffer. Therefore, in each layer of the transmission node DU 800₁, transferring the packet data of which the signal processing is completed may be substituted with a process of transferring address information of the memory buffer allocated for the bearer including the packet data. In this case, when the transmission node DU 800₁ completes the digital signal processing of the packet data and transfers the packet data to the transmission node RU 800₂, the transmission node DU 800₁ reads the data of the memory buffer to write the read data in the memory buffer allocated for an interface between the transmission node DU 800₁ and the transmission node RU 800₂.

When the transmission node DU 800₁ completes the digital signal processing of the packet data, a coded or modulated data signal sequence may be transferred to an RU function block included in the transmission node RU 800₂. The data signal sequence transferred through the LTE transmission path may be transferred from the LTE PHY layer 813 of the transmission node DU 800₁ to an LTE RU function block 814 of the transmission node RU 800₂. The data signal sequence transferred through the WLAN transmission path may be transferred from the WLAN PHY layer 823 of the transmission node DU 800₁ to a WLAN RU function block 824 of the transmission node RU 800₂. The data signal sequence transferred through the U-LTE transmission path may be transferred from the U-LTE PHY layer 833 of the transmission node DU 800₁ to the U-LTE RU function block 834 of the transmission node RU 800₂. The LTE RU function block 814, the WLAN RU function block 824, and a U-LTE RU function block 834 included in the transmission node RU 800₂ perform analog signal processing and an RF function required in the U-LTE system, and the like with respect to the data signal sequence received from the PHY layer of the transmission node DU 800₁ to transmit the corresponding data signal sequence to a radio section.

In the exemplary embodiment of the present invention, in the case of the RRA of the LTE system and the WLAN system, the PDCP layer 810 of the transmission node DU 800₁ may transfer the PDCP PDU to the LTE RLC layer 811 or the convergence function layer 821. When the convergence function block 821 is not introduced in the transmission node DU 800₁, the PDCP PDU of the PDCP layer 810 may be transferred to the WLAN MAC layer 822. That is, the packet data of the same bearer may be transferred to the LTE system or the WLAN system. In addition, when there is retransmission function of the PDCP PDU in the WLAN system or retransmission through the WLAN system is unsuccessful, the PDCP PDU may be retransmitted through the LTE system, and as a result, service quality may be satisfied.

Meanwhile, the reception apparatus may receive the packet data configuring a bearer through the RRA. That is, the reception apparatus may receive the packet data through an LTE reception path, a WLAN reception path, or a U-LTE reception path according to the type of the system in which the RRA is supported.

The RU function block for each system, which is included in the reception node RU 800₄ performs RF signal processing for each system to generate the data signal sequence, and may transfer the data signal sequence to the PHY function block according to the reception path for each system, which is included in the reception node DU 800₃.

When the data signal sequence is received through the LTE reception path, an LTE RU 815 may transfer the data signal sequence of which the RF signal processing is completed to an LTE PHY layer 816 of the reception node DU 800₃. The LTE PHY layer 816 generates the TrBK in the data signal sequence through a demodulation or decoding process and the TrBK is transferred to an LTE MAC layer 817. The LTE MAC layer 817 may generate the MAC SDU through the TrBK received from the LTE PHY layer 816 and transfer the generated MAC SDU to an LTE RLC layer 818. The LTE RLC layer 818 that receives the RLC PDU may generate the RLC SDU through header information such as a logical channel identifier (LCID), the SN, the FI, or the LI and transfer the RLC SDU to a PDCP layer 840. In this case, the LTE RLC layer 818 may generate the RLC SDU by arranging the packet data according to the SN order with the header information such as the SN and the like and RLC status information for supporting the retransmission (ARQ) function. That is, the LTE RLC layer 818 sequences the packet data by using the SN to generate the RLC SDU and transfer the RLC SDU to a PDCP layer 840.

When the data signal sequence is received through the WLAN reception path, a WLAN RU 825 may transfer the data signal sequence of which the RF signal processing is completed to a WLAN PHY layer 826. The WLAN PHY layer 826 that receives the data signal sequence performs the digital signal processing of the physical layer of the WLAN system, which includes the demodulation or decoding to transfer the packet data to a WLAN MAC layer 827. The WLAN MAC layer 827 transfers the packet data to the PDCP 840 by performing the WLAN MAC function. The reception node DU 800₃ according to the exemplary embodiment of the present invention may include a convergence function block 828 for an interface between the LTE-based PDCP layer 840 and the WLAN MAC layer 827. The convergence function block 828 may convert the MAC SDU of the WLAN system according to the PDCP PDU of the PDCP layer 840 of the LTE system. That is, the convergence function block 828 that receives the MAC SDU which is the packet data from the WLAN MAC layer 827 may convert the MAC SDU into the PDCP PDU according to a structure of the PDCP PDU of the PDCP layer 840 of the LTE system and transfer the PDCP PDU to the PDCP layer 840.

When the data signal sequence is received through the U-LTE reception path, the U-LTE RU 835 may transfer the data signal sequence of which the RF signal processing is completed to a U-LTE PHY layer 836. The U-LTE MAC layer 836 may generate the TrBK by demodulating or decoding the received data signal sequence and transfer the generated TrBK to a U-LTE MAC layer 837. The U-LTE MAC layer 837 may generate the MAC SDU based on the TrBK received from the U-LTE PHY layer 836 and transfer the generated MAC SDU to a U-LTE RLC layer 838. The U-LTE RLC layer 838 sequences the packet data through the received RLC PDU to generate the RLC SDU and transfer the generated RLC SDU to the PDCP layer 840. That is, the U-LTE RLC layer 838 may sequence the packet data by using the SN and transfer the RLC SDU to the PDCP layer 840. When the radio protocol is configured without the U-LTE RLC layer 831 in the U-LTE transmission path, the reception path may be formed without the U-LTE RLC layer 838 even in the U-LTE reception path, and in this case, the packet data may be directly transferred from the U-LTE MAC layer 837 to the PDCP layer 840. In this case, the in-sequence of the packet data may be performed in the U-LTE MAC layer 837 or through recombination and re-ordering in the PDCP layer 840.

The PDCP layer 840 may transfer the packet data transferred through each path which participates in supporting the RRA, such as the LTE reception path, the WLAN reception path, or the U-LTE reception path to the higher layer through the same bearer.

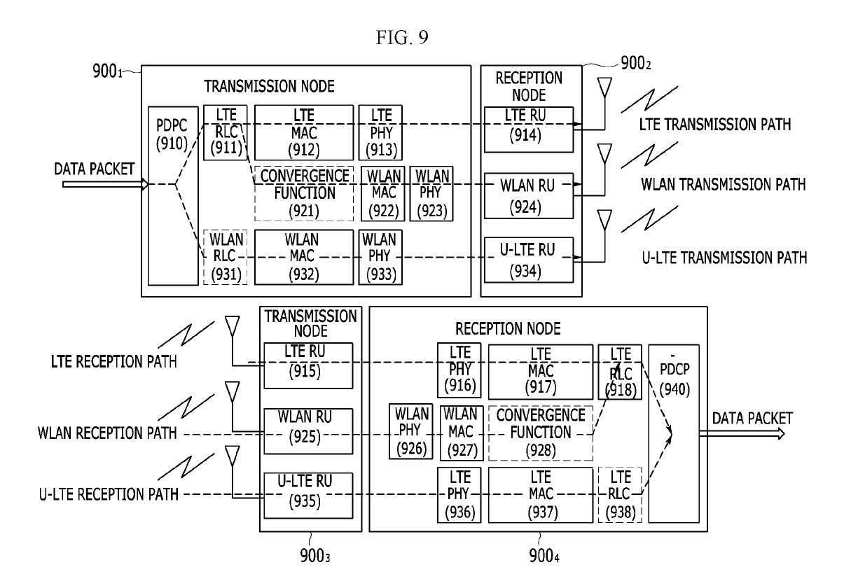

FIG. 9 is a diagram illustrating a protocol stack of a U-LTE system according to another exemplary embodiment of the present invention.

Referring to FIG. 9, the packet data may be transmitted through the bearer, and a transmission node DU 900₁ and a transmission node RU 900₂ may support the LTE system, the WLAN system, and the U-LTE system using the frequency in the unlicensed band. In the U-LTE system according to another exemplary embodiment of the present invention illustrated in FIG. 9, even the LTE RLC layer may partially support the RRA function. For example, when the RRA is applied to the radio resources of the LTE system and the WLAN system, the LTE RLC layer transfers the packet data to the WLAN MAC layer. That is, it is determined whether the packet data is transmitted through the LTE transmission path or the WLAN transmission path by scheduling in which the base station transmits the packet data and the packet data to be transferred through the LTE transmission path may be transferred to the LTE MAC layer and the packet data to be transferred through the WLAN transmission path may be transferred through the WLAN transmission path.

The packet data of a bearer is transferred from a PDCP layer 910 to an LTE RLC layer 911 or a U-LTE RLC layer 931 from the transmission node DU 900₁. When the packet data is transmitted through the LTE transmission path, the packet data is sequentially transferred to the LTE RLC layer 911, an LTE MAC layer 912, and an LTE PHY layer 913 in the transmission node DU 900₁. An LTE RU 914 of the transmission node RU 900₂ that receives the data signal sequence from the LTE PHY layer 913 performs the RF function and the analog signal processing for the LTE system to transmit the data signal sequence.

When the packet data is transmitted through the WLAN transmission path, the LTE RLC layer 911 of the transmission node DU 900₁ transfers the RLC PDU to a WLAN MAC layer 922. In this case, the LTE RLC layer 911 allocates a separate logical channel identifier and displays the allocated logical channel identifier in the LTE RLC header to identify whether the transmission LTE RLC or reception LTE RLC layer is transferred through the LTE system or the WLAN system. The WLAN MAC layer 922 maps the RCL PDU received from the LTE RLC layer 911 to the data field according to a frame format of the WLAN MAC layer 922 and adds header information adopted in the MAC layer 922 of the WLAN system to the RLC PDU, and thereafter transfers the added header information to a WLAN PHY layer 923. The WLAN PHY layer 923 may perform the digital signal processing in the physical layer of the WLAN system, which includes the coding or the modulation defined in the WLAN system. Thereafter, the WLAN PHY layer 923 transfers the data signal sequence to a WLAN RU 924 of the transmission node RU 900₂. The WLAN RU 924 transmits the signal by performing the analog signal processing and the RF function.

The transmission node DU 900₁ according to another exemplary embodiment of the present invention may include a convergence function block 921 for an interface between the LTE-based LTE RLC layer 911 and the WLAN MAC layer 922. The convergence function block 921 may convert the RLC PDU of the LTE system according to the MAC SDU structure of the WLAN system. In addition, the convergence function block 921 receives the packet data from the LTE RLC layer 911 to convert the received packet data to suit the protocol structure of the WLAN system, and thereafter transfer the converted packet data to the WLAN MAC layer 922.

When the packet data is transmitted through the U-LTE transmission path, the packet data may be sequentially transferred to the PDCP layer 910, the U-LTE RLC layer 931, a U-LTE MAC layer 932, and a U-LTE PHY layer 933 in the transmission node DU 900₁. The U-LTE RLC layer 931 configures the RLC PDU with the received PDCP PDU and transfers the configured RLC PDU to the U-LTE MAC layer 932. When the radio protocol is configured without the U-LTE RLC layer 931 in the U-LTE transmission path, the packet data may be directly transferred from the PDCP LAYER 910 to the U-LTE MAC layer 932 or transferred from the PDCP layer 940 to the LTE RLC layer 911, and the LTE RLC layer 911 may transfer the packet data to the U-LTE MAC layer 932. When a U-LTE radio protocol is defined without the U-LTE RLC layer 931 to support the RRA function using the LTE system and the U-LTE system, the PDCP layer 910 transfers the PDCP PDU according to a data area of the MAC PDU of the U-LTE MAC layer 932 and the LTE RLC layer 911 also transfers the PDCP PDU according to the data area of the MAC PDU of the U-LTE MAC layer 932. The U-LTE MAC layer 932 transfers the MAC PDU to the U-LTE PHY layer 933 by performing the processing function for the transport channel. In addition, the U-LTE PHY layer 933 performs the digital signal processing of the physical layer, which includes the coding or modulation of the MAC PDU (alternatively, the TrBK) received from the U-LTE MAC, and transfers the data signal sequence of which the digital signal processing is completed to a U-LTE RU 934.

An LTE RU function block 915, a WLAN RU function block 925, and a U-LTE RU function block 935 of the transmission node RU 900₂ perform the analog signal processing and the RF function required in the corresponding system, and the like with respect to the data signal sequence received from the PHY layer of the transmission node DU 900₁ to transmit the corresponding data signal sequence to the radio section.

When the packet data is received through the LTE reception path, the LTE RU 915 receives the signal and completes the RF signal processing of the received signal, and thereafter transfers the data signal sequence to a TLE PHY layer 916. The LTE PHY layer 916 transfers the received TrBK generated through the demodulation or decoding to an LTE MAC layer 917. The LTE MAC layer 917 generates the MAC SDU by using the TrBK and transfers the generated MAC SDU to an LTE RLC layer 918. The LTE RLC layer 918 generates the RLC SDU from the RLC PDU by using the header information such as the LCID, the SN, the FI, or the LI, and transfers the generated RLC SDU to the PDCP layer 940. In this case, the LTE RLC layer 918 sequences the packet data according to the SN by using the header information such as the SN and the like and the RLC status information for supporting the retransmission function to generate the RLC SDU. That is, the LTE RLC layer 918 may sequence the packet data by using the SN.

When the packet data is received through the WLAN reception path, a WLAN RU 925 transfers the data signal sequence of which the RF signal processing is completed to a WLAN PHY layer 926. The WLAN PHY layer 926 performs the digital signal processing of the physical layer of the WLAN system, which includes the demodulation or decoding of the received data signal sequence and transfers the data signal sequence of which the digital signal processing is completed to a WLAN MAC layer 927. The WLAN MAC layer 927 transfers the MAC SDU to the LTE RLC layer 918 by performing the WLAN MAC function. Alternatively, a reception node DU 900₃ according to another exemplary embodiment of the present invention may include a convergence function block 928 for an interface between the LTE RLC layer 918 and the WLAN MAC layer 927. The convergence function block 928 positioned between the LTE RLC layer 918 and the WLAN MAC layer 927 may convert the MAC SDU of the WLAN system according to the RLC PDU of the LTE system RLC LAYER 918. In another exemplary embodiment of the present invention, the convergence function block 928 converts the packet data configuring the MAC frame according to the RLC PDU of the LTE system RLC layer 918 to transfer the converted packet data to the LTE RLC layer 918.

The LTE RLC layer 918 that receives the RLC PDU from the WLAN MAC layer 927 or the convergence function block 928 generates the RLC SDU by using the header information such as the LCID, the SN, the FI, or the LI, and transfers the generated RLC SDU to the PDCP layer 940. In this case, the LTE RLC layer 918 sequences the packet data according to the SN by using the header information such as the SN and the like and the RLC status information for supporting the retransmission function to generate the RLC SDU. That is, the LTE RLC layer 918 may transfer the RLC SDU sequenced according to the SN to the PDCP layer 940.

When the packet data is received through the U-LTE reception path, the U-LTE RU 935 transfers the data signal sequence of which the RF signal processing is completed to a U-LTE PHY layer 936. The U-LTE PHY layer 936 transfers the received TrBK generated through the demodulation or decoding to a U-LTE MAC layer 937. The U-LTE MAC layer 937 generates the MAC SDU by using the TrBK and transfers the generated MAC SDU to a U-LTE RLC layer 938. The U-LTE RLC layer 938 sequences the packet in the RLC PDU to generate the RLC SDU and transfer the generated RLC SDU to the PDCP layer 940. In this case, the U-LTE RLC layer 938 may sequence the packet data by using the SN to generate the RLC SDU.

When the U-LTE RLC layer 931 does not exist in the radio protocol of the U-LTE transmission path, the U-LTE RLC layer 938 does not exist even in the radio protocol of the U-LTE reception path. In this case, the packet data may be transferred from the U-LTE MAC layer 937 to the PDCP layer 940 or the packet data may be transferred from the U-LTE MAC layer 937 to the LTE RLC layer 918. When the packet data is transferred from the U-LTE MAC layer 937 to the PDCP layer 940, the in-sequence of the packet data may be performed or the in-sequence of the packet data may be performed through the recombination and ordering in the PDCP layer 940.

The PDCP layer 940 may transfer the packet data received from the LTE RLC layer 918, the WLAN MAC layer 927, the convergence function block 928, the U-LTE MAC layer 937, or the U-LTE RLC layer 938 to the higher layer through the same bearer in the LTE reception path, the WLAN reception path, or the U-LTE reception path which participates in supporting the RRA.

As described above, the convergence function block may be selectively introduced in the WLAN transmission path and the WLAN reception path, and may be omitted in another exemplary embodiment of the present invention. Further, the U-LTE RLC layer may be selectively introduced in the U-LTE transmission path and the U-LTE reception path, and may be omitted in the U-LTE radio protocol according to another exemplary embodiment of the present invention.

In the radio protocol structure for supporting RRA according to another exemplary embodiment of the present invention, the U-LTE system using the frequency in the unlicensed band may include only the physical layer and the MAC layer. That is, in the transmission node DU 900₁ and a reception node DU 900₃ of FIGS. 8 and 9, the U-LTE protocol layer includes only the U-LTE MAC layer and the U-LTE PHY layer. In this case, aggregation and separation of the packet data for the RRA may be performed in the LTE RLC layers on the transmission and reception paths.

For example, in FIG. 9, the packet data may be transferred to the LTE RLC through the DPCP layer. In this case, the base station performs the scheduling to determine one of the LTE transmission path and the U-LTE transmission path as the transmission path of the packet data. When the transmission path of the packet data is the LTE transmission path, the packet data is transferred to the LTE MAC layer, and when the transmission path of the packet data is the U-LTE transmission path, the packet data is transferred to the U-LTE MAC layer. The U-LTE MAC layer transfers the data signal sequence to the U-LTE RU, and the data signal sequence is subjected to the analog signal processing and the RF function to be transmitted to the radio section. The U-LTE RU of a reception node RU 900₄ performs the RF signal processing of the received signal and thereafter, transfers the corresponding data signal sequence to the U-LTE PHY layer of the reception node DU 900₃. The U-LTE PHY layer transfers the data signal sequence subjected to the digital signal processing such as the demodulation and the decoding to the U-LTE MAC layer. In addition, the U-LTE MAC layer generates the MAC SDU to transfer the MAC SDU to the LTE RLC layer. That is, when the radio protocol of the WLAN system or the U-LTE system using the frequency in the unlicensed band is constituted only by the PHY layer and the MAC layer, the LTE RLC layer may perform separation and aggregation of the packet data for supporting the RRA. In this case, although the MAC layer of the WLAN system or the U-LTE system does not support the retransmission function such as the ARQ, the retransmission function of the LTE RLC layer may be used to improve transmission and reception reliability of the packet data. For example, when a transmission failure occurs on the transmission and reception paths of the WLAN system or the U-LTE system while supporting the RRA, the LTE RCL layer at the transmission side may retransmit the RLC PDU of which the transmission is unsuccessful through an available communication path, and the LTE RLC layer at the reception side performs reordering by using the SN of the RLC PDU to transfer the RLC SDU to the higher layer.

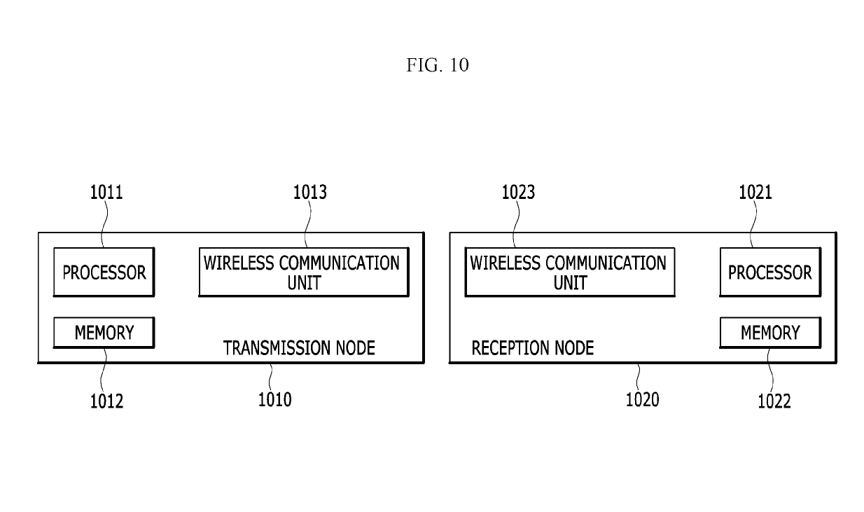

FIG. 10 is a block diagram illustrating a wireless communication system according to another exemplary embodiment of the present invention.

Referring to FIG. 10, the wireless communication system according to the exemplary embodiment of the present invention includes a transmission node 1010 and a reception node 1020.

The transmission node 1010 includes a processor 1011, a memory 1012, and a radio frequency (RF) unit 1013. The memory 1012 is connected with the processor 1011 to store various information for driving the processor 1011. The RF unit 1013 is connected with the processor 1011 to transmit and/or receive a radio signal. The processor 1011 may implement a function, a process, and/or a method which are proposed in the present invention. In this case, in the wireless communication system according to the exemplary embodiment of the present invention, a radio interface protocol layer may be implemented by the processor 1011. An operation of the transmission node 1010 according to the exemplary embodiment of the present invention may be implemented by the processor 1011.

The reception node 1020 includes a processor 1021, a memory 1022, and an RF unit 1023. The memory 1022 is connected with the processor 1021 to store various information for driving the processor 1021. The RF unit 1023 is connected with the processor 1021 to transmit and/or receive the radio signal. The processor 1021 may implement a function, a process, and/or a method which are proposed in the present invention. In this case, in the wireless communication system according to the exemplary embodiment of the present invention, the radio interface protocol layer may be implemented by the processor 1021. An operation of the transmission node 1020 according to the exemplary embodiment of the present invention may be implemented by the processor 1021.

In the exemplary embodiment of the present invention, the memory may be positioned inside or outside the processor, and the memory may be connected with the processor through various already known means. The memory is various types of volatile or non-volatile storage media, and the memory may include, for example, a read-only memory (ROM) or a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a service using radio resource aggregation by a base station, the method comprising:
receiving, from a terminal, a measurement result for one or more nodes positioned on the periphery of the terminal; and
aggregating radio resources of a first node among one or more nodes and the base station based on the measurement result to provide the service to the terminal through the first node.

2. The method of claim 1, further comprising:
transmitting and receiving control information to and from the first node; and
transmitting information on the first node to the terminal.

3. The method of claim 1, wherein the providing includes transferring all packet data of the service to the terminal through the first node when off-loading is supported.

4. The method of claim 1, wherein the providing includes transferring the packet data of the service to the terminal by aggregating one or more first carriers allocated to the base station and one or more second carriers allocated to the first node when carrier aggregation (CA) is supported.

5. The method of claim 1, wherein the providing includes transferring the packet data to the terminal by aggregating one or more first radio resources allocated to the base station and one or more second radio resources allocated to the first node when radio resource aggregation (RRA) is supported.

6. The method of claim 1, wherein the first node is a node of a mobile communication network using an unlicensed frequency band.

7. A method for receiving a service of an apparatus of a mobile communication network using an unlicensed frequency band, the method comprising:
discovering whether another wireless apparatus using a contention-based area exists in the contention based area included in a radio frame of the mobile communication network; and
receiving, when occupying a first radio resource included in the contention based area is possible based on the discovery result, the service from a base station of the mobile communication network or a node of the mobile communication network using the unlicensed frequency band by using the first radio resource.

8. The method of claim 7, further comprising:
being allocated a second radio resource in a non-contention based area included in the radio frame through scheduling of the base station; and
receiving the service by using the first radio resource or the second radio resource.

9. The method of claim 8, wherein the contention based area and the non-contention based area occupy different parts in a time domain of the radio frame.

10. The method of claim 8, wherein the contention based area and the non-contention based area occupy different parts in a frequency domain of the radio frame.

11. The method of claim 9, wherein each of the contention based area and the non-contention based area includes one or more subframes, and the number of one or more subframes included in the contention based area and the number of one or more subframes included in the non-contention based area are different for each radio frame.

12. The method of claim 10, wherein each of the contention based area and the non-contention based area includes one or more subcarriers, and the number of one or more subcarriers included in the contention based area and the number of one or more subcarriers included in the non-contention based area are different for each radio frame.

13. The method of claim 8, wherein each of the contention based area and the non-contention based area includes one or more physical layer control channels to which the unit of the radio resource, a configuration scheme of the radio resource, and a determination scheme of a modulation and coding scheme (MCS) are similarly applied, and the number of one or more physical layer control channels included in the contention based area and the number of one or more physical layer control channels included in the non-contention based area are different for each radio frame.

14. The method of claim 7, wherein the discovering includes sensing whether other wireless apparatus exist on the periphery before requesting the radio resource to the base station or the node of the mobile communication network.

15. The method of claim 7, wherein the discovering includes discovering whether other wireless apparatus using the contention based area exist by measuring energy of a signal of the radio resource transmitting system information.

16. A transmission apparatus for transmitting packet data by using a radio resource of a mobile communication network and a radio resource of a wireless local area network, the transmission apparatus comprising:
a scheduler determining a transmission path of the packet data as one of a first transmission path of the mobile communication network, a second transmission path of the wireless local area network, and a third transmission path of the mobile communication network using a frequency in a unlicensed band; and
a control unit transferring the packet data to one of the first transmission path, the second transmission path, and the third transmission path based on the determination of the scheduler.

17. The transmission apparatus of claim 16, further comprising a convergence function block for an interface between a packet data convergence protocol (PDCP) layer based on the mobile communication network and a media access control (MAC) layer of the wireless local area network.

18. The transmission apparatus of claim 17, wherein the convergence function block converts a packet data unit (PDU) of the PDCP layer in accordance with a service data unit (SDU) of the MAC layer.

19. The transmission apparatus of claim 16, wherein the control unit serves as the packet data convergence protocol (PDCP) layer of the mobile communication network.

20. The transmission apparatus of claim 16, wherein the control unit serves as a radio link control (RLC) layer of the mobile communication network.
